(19) United States
(12) Patent Application Publication
(10) Pub. No.: US 2008/0052207 A1
(43) Pub. Date: Feb. 28, 2008

(54) SYSTEMS AND METHODS FOR ISSUING AND SERVICING A LOW CREDIT RISK WEIGHT SOVEREIGN DEBT SECURITY

(76) Inventor: Renan C. Paglin, Manila (PH)

Correspondence Address: Smetrix Financial;Renan Paglin, Herrera Tower, Suite 1523, 98 V.A. Rufino St., Makati City, 1226, omitted

(21) Appl. No.: 11/842,968

(22) Filed: Aug. 22, 2007

Related U.S. Application Data
(60) Provisional application No. 60/839,698, filed on Aug. 24, 2006.

(51) Int. Cl. G06Q 40/00

(52) U.S. Cl. 705/35

(57) ABSTRACT

Systems and methods for the issuance of low-risk debt securities, referred to as LITE Securities, in exchange for high-risk debt securities which have been issued by an emerging-market sovereign government in the global capital market and which have been purchased by an investor which resides in the sovereign government's country. Investment in LITE Securities result in little or no loss of market liquidity for the investor compared to the market liquidity of the original high-risk debt securities despite the LITE Securities itself being less liquid. The systems and methods for the servicing of the LITE Securities are convenient for the issuer as no new debt securities will need to be serviced. The systems and methods disclosed also allow resident institutional investors such as banks to more efficiently use regulatory capital against debt issued by its own sovereign, as prescribed by the international bank capital standards known as the Basel Accord.

### CROSS-REFERENCE TO RELATED APPLICATIONS

This application claims the benefit of Provisional Patent Application Ser. No. 60/839698 which was filed on Aug. 24, 2006 by the present inventor.

### FIELD OF INVENTION

This invention relates to emerging-market sovereign finance. More specifically, this invention relates to sovereign debt securities which are traded in the global capital market, and to foreign currency exchange contracts, and to payment methods for servicing debt securities, and to the management of economic and regulatory capital under the international bank capital standard known as the Basel Accord.

### BACKGROUND OF THE INVENTION

Sovereign governments of foreign countries, especially emerging market countries, have often needed to issue debt to support fiscal requirements. In the past, different classes of debt issued by such sovereign governments were denominated in different currencies. For investors, such as banks, which reside in the sovereign's country, the sovereign usually issued debt which was denominated in the local currency of the country. On the other hand, for investors which reside outside the sovereign's country, the sovereign usually issued debt that was denominated in hard currencies that are foreign to that sovereign. This hard currency denominated debt was governed by laws foreign to the sovereign and adjudicated in courts outside the sovereign's country. Investors which reside outside the sovereign's country and which operated outside the jurisdiction of that country's central bank often preferred not to rely on the laws or courts of the sovereign issuer, especially if the sovereign was from an emerging market country. On the other hand, investors which are under the sovereign's jurisdiction because they are residents of that sovereign's country are often quite willing to invest in debt that is governed by that country's laws and adjudicated by that country's courts.

During the last two decades, many emerging market countries liberalized their capital accounts so that it became permissible, and even common, for residents of those countries to own assets which are denominated in hard currency which are foreign to that country. Banks in those countries were liberalized to accept hard currency deposits from residents. This, in turn, created a demand for hard currency denominated assets for those banks. Debt issued in the global capital market by the sovereign of those emerging market banks which were originally intended for non-resident investors often became a favorite asset for those banks which naturally favored their own government's debt, regardless of whether that debt was denominated in local or hard currency.

Previously, those resident banks which invested in their own sovereign's hard currency debt had an advantage, in the allocation of regulatory capital, compared to non-resident banks. Under the international bank capital standards known as Basel I of the Basel Capital Accord which was adopted in 1988 (but revised in a major way in 2004), resident banks did not have to allocate any regulatory capital to any debt claim on their own sovereign, regardless of the currency in which that debt claim was denominated. Non-resident banks, however, often had to allocate significant regulatory capital if they owned such debt, especially if it was issued by an emerging market government, because for those non-resident banks such debt was issued by a foreign sovereign.

The difference in capital requirements for holding sovereign debt for resident versus non-resident banks has been removed by revisions to the international capital standards, known as Basel II, which was adopted in 2004. Basel II requires that banks which own hard currency debt assign a credit risk weight for purposes of calculating capital requirements that is based on the external foreign currency credit rating of that debt. Unlike Basel I, the credit risk weight for hard currency debt does not depend on whether the issuer is a foreign sovereign or the banks' own sovereign. For banks located in lower rated countries, especially those with a foreign currency credit rating of speculative grade (BB+ or lower), Basel II now requires those banks which hold sovereign hard currency debt to assign a significant risk weight of at least 100%. However, debt issued by the sovereign, which debt is denominated in the sovereign's local currency, can continue to be given a risk weight equal to zero. The different capital treatment of hard currency versus local currency debt has created a preference for banks to hold local currency debt instead of hard currency debt issued by their own sovereign. However, some resident banks need to hold sovereign debt that is denominated in hard currency because prudent risk management requires avoidance of mismatches between assets and liabilities that result in foreign exchange risk.

Bank regulatory capital, which includes shareholders' equity, is generally much more expensive than other forms of bank funding. Thus, it is more profitable for a bank to maximize the portion of an asset which can be funded by cheaper sources of funding such as deposits, while minimizing the portion which needs to be supported by regulatory capital, which is much more expensive than other sources of bank funding. Having a lower risk weight assigned to a bank's asset allows the bank to minimize its use of expensive capital to fund such an asset.

Many emerging market sovereigns have issued hard currency sovereign bonds in the past. These sovereign bonds were originally designed for investors which did not reside in the country of the sovereign. However, significant amounts of these sovereign bonds have been purchased by resident banks which were not the originally targeted investors. However, such resident banks often have different needs from non-resident investors because of their liability structures. Resident banks wish to manage their debt portfolio so that it will provide the best return adjusted for the amount of regulatory capital that would have to be allocated to that debt portfolio. Sovereigns, on the other hand, wish to offer debt instruments that maximize value for various classes of investors, whether those investors reside within or without the sovereign's country.

FIG. 7a shows a flowchart regarding the prior art method with respect to the investing in traditional hard currency sovereign debt, usually in the form of global bonds issued by a sovereign government under New York or English law. A detailed description of FIG. 7a can be found in the part of the present application referred to as “Detailed Description of the Drawings”.

Another important quality of debt securities is market liquidity. Market liquidity refers to the total number and value of such debt securities that are available to be bought or sold in the secondary market so that a large amount being offered by sellers, or bid by buyers, does not greatly affect the market price of the debt securities. Investors prefer securities which have greater market liquidity, and are willing to accept a lower yield for such securities.

### OBJECTS AND ADVANTAGES

It is an object of the present invention in one or more embodiments to create a new kind of hard currency denominated debt instrument to be issued by a sovereign government to replace a prior-art hard currency debt instrument, commonly referred to as global bonds, that has been previously issued by the sovereign government to a bank investor which resides in that sovereign's country. The benefit is that the sovereign is able to tailor different kinds of hard currency debt instruments that are best suited for different investor segments.

Another object of the present invention is to enable a bank residing in an emerging market country and which invests in its own sovereign's hard-currency denominated debt to book a hard-currency denominated debt asset which has a much lower credit risk weight compared to global bonds. The benefit is that the bank is able to allocate less regulatory capital to the new kind of debt while allocating more regulatory capital for use by its other customers, thereby creating more financing opportunities for the other sectors of the domestic economy.

Another object of the present invention is to create a new kind of hard currency denominated debt issued by the sovereign which would have a lower risk of default for a resident bank which invests in that debt. The resident bank benefits because the source of repayment, which may be in local currency, is more readily available to the borrower to use as repayment. Another benefit is that the economic performance of the new kind of debt can be more correlated to the bank's liability structure.

Another object of the present invention is to provide the resident banks which invest in the new kind of debt with access to the same level of market liquidity from the global capital market that those banks had when they invested in the global bonds issued by the sovereign. The benefit to the bank is that it can enjoy lower risk and have to allocate less regulatory capital, without giving up market liquidity for its investment.

Another objective of the present invention is to allow operational simplicity for the sovereign issuing the new kind of debt. The benefit is that the sovereign can service both the prior-art debt as well as debt created through the present invention using the payment procedure that the sovereign issuer has been using for the previous prior-art debt.

Other objectives and advantages of the present invention will become apparent from the description of the present invention in the specifications and drawings of this application.

### SUMMARY OF THE INVENTION

The present application discloses systems and methods by which a sovereign which issues hard currency debt referred to in the present application as Hard Currency Bonds (such as debt securities denominated in U.S. dollars), to use the cash flow from such debt instrument to service a new security to be issued by the sovereign, called a LITE Security. The LITE Security is received in exchange for the Hard Currency Bond and entails a significantly lower capital charge compared to the original Hard Currency Bond. The LITE Security, like the Hard Currency Bond, is also denominated in hard currency, but it is created through the use of local currency denominated debt and foreign currency exchange contracts. This present invention also reduces the economic risk of resident banks, without having to change the proportion of their assets which are invested in hard currency claims against the sovereign. The present invention is practiced with the participation of the sovereign which issued the debt. The present invention allows those resident banks to enjoy most of the benefits of owning Hard Currency Bonds while avoiding the high capital charge. However, the present invention should not be considered as simply a risk weight reduction method devoid of economic reality. The present invention permits the creation of a new debt security that is much safer for a resident bank to own compared to the original hard currency debt issued by the sovereign in the prior art.

The present invention allows the resident banks to not only reduce the regulatory capital that they would be required to hold, but also to reduce the economic risk, for holding Hard Currency Bonds issued by their sovereign. Although it may appear that the LITE Security and the prior-art debt (i.e. Hard Currency Bonds,) for which the LITE Security has been exchanged are equally risky for any investor because both instruments are denominated in hard currency, the LITE Securities created through the use of the present invention is actually a safer investment for the resident banks compared to the Hard Currency Bond that they previously owned. This is because the LITE Security, although denominated in hard currency for accounting purposes, is actually a debt claim based on local currency for legal purposes. Regardless of whether or not the sovereign is experiencing a financial crisis, the sovereign can be expected to have greater access to local currency, which is issued by its central bank, compared to hard currency, which has to be obtained by the central bank from sources outside the country.

An important benefit is the continued ability to maintain price parity between LITE Securities and Hard Currency Bonds. Although resident banks desire to hold debt issued by their sovereign which minimizes the use of regulatory capital, they also desire to access the global liquidity that is available from investors worldwide who wish to invest in the sovereign's debt securities referred to as global bonds. Global bonds are traded in the world's major financial centers. Structuring debt securities as global bonds is normally the best way for the issuer to permit trading of such debt securities so as to maximize the number of investors who become interested in such debt securities. However, foreign investors which reside outside the sovereign's country have different criteria for those global bonds compared to investors which reside within the country.

For example, a resident bank often assigns much greater value and utility in receiving local currency payments because it has more uses of such local currency. Most, if not all, of the resident bank's customers, including depositors, deals regularly in such local currency. In contrast, a non-resident investor probably has little use of such local currency payment because it has no expenditures in that country. Often, the only possible use for the non-resident investor is to exchange the local currency for hard currency with the central bank so that the non-resident investor can send the hard currency to its home country. Both exchanging and sending hard currency may be difficult and costly or perhaps impossible during a time of financial crisis affecting the emerging market country. A resident bank would likely be more willing to place higher value on local currency as alternative way of being repaid, compared to a non-resident investor.

Another reason is that a resident bank may be permitted to assign a much lower credit risk weight (which may be as low as zero) for regulatory capital purposes for certain debt securities issued by that bank's sovereign, while other banks which reside outside that country may have to charge a much higher risk weight for those same debt securities. This is because the debt securities are denominated in a currency that is local for the Resident Banks. The same currency would be considered foreign for those banks which reside outside the sovereign's country. The preferential risk-weight treatment under Basel II for sovereign claims relates only to claims denominated in local currency with respect to country where that bank resides. Thus, the preferential risk weight can be enjoyed only by Resident Banks. Non-resident banks would have no regulatory capital advantage by holding such a local currency denominated security.

The present invention allows a sovereign to continue issuing traditional global bonds denominated in hard currency without diminishing the demand from resident banks to invest in the security because of the more burdensome capital requirements imposed by Basel II. The present invention allows the traditional global bonds (i.e. Hard Currency Bonds) to be exchanged with the sovereign and re-issued as a LITE Security, which is created and sold through the methods described in the present invention. The methods disclosed by the present invention will not only benefit the regulatory capital of resident banks which use the present invention, but it will also benefit their true economic capital because it lowers their real risk. At the same time, the present invention is convenient for the sovereign because it does not have to divide the market liquidity available for its bonds, whether those bonds are obtained through the prior art or through the use of the present invention. The two kinds of securities, namely the prior-art global bond and the present-invention LITE Security, can become largely fungible through the use of the present invention.

The LITE Security can be converted to the global bond (i.e. Hard Currency Bond) by a resident bank investor if the global bond rises in value relative to the LITE Security. Conversely, the sovereign issuer can buy back global bonds and issue LITE Securities during the opposite situation when the LITE Security rises in value relative to global bonds. Excess demand for the LITE Securities from resident banks can be channeled to support the price of global bonds through purchase of global bonds in exchange for issuance of LITE Securities. Conversely, excess demand for the global bonds can be channeled to support the price of LITE Securities through the exchange of LITE Securities for the corresponding global bond which can then be sold in the global capital market to meet the excess demand.

From the point of view of debt service disbursement operations, the present invention also allows the sovereign issuer to service both the global bonds and the LITE Securities, by only servicing one class of securities, the global bonds. Thus, from an operational view point, the sovereign issuer only has the global bonds to worry about, and need not worry about the LITE Securities. These global bonds can be outstanding securities which have already been issued by the sovereign. The present invention allows the debt service payments generated by the global bonds to service both global bonds and LITE Securities. The same check or payment instruction made by the sovereign to the fiscal agent of the global bonds can service both investors in global bonds as well as investors in LITE Securities.

In addition, the present invention allows the re-routing of funds to service the LITE Securities that would not be possible to service the global bonds at a time of debt moratorium or default. This creates a benefit for the investors of the LITE Securities because there are a greater number of ways that they can be paid compared to how they would get paid if they were to hold only a global bond.

The following are the definitions for terms as used in the present application:

“Custodian” as used in the present application refers to an agent which physically or legally holds certain debt securities, and which acts on behalf of a Resident Bank and/or a Sovereign Government to perform the actions promised by the Resident Bank to the Sovereign Government, or vice versa, under the Master Agreement governing the LITE Security. The Custodian may also be acting on behalf of a Trustee which has been established for the benefit of the Resident Banks. In whose behalf the Custodian is acting for will be more clear and apparent in the part of the present application where the Custodian's role is more fully described.

“Cross Currency Swap” as used in the present application refers to an agreement between the Sovereign Government and the Resident Banks to exchange a cash flow stream of principal and interest payments in one currency for a stream of principal and interest payments in another currency over multiple specified periods. An example of a Cross Currency Swap is an agreement between the Sovereign Government and the Resident Bank or between the Sovereign Government and the trustee of the Resident Bank, whereby the Sovereign Government agrees to pay the Resident Bank a stream of hard currency payments with amount equal to and simultaneous with the hard currency payments due under a Hard Currency Bond. In exchange, the Resident Bank, or its trustee, agrees to pay to the Sovereign Government a stream of local currency payments with amount equal to and simultaneous with the local currency payments due under the Local Currency Bond comprising the LITE Security.

“External Cash Account” as used in the present application refers to a record or set of records maintained by a Settlement Provider or a Resident Central Bank, to keep track of the readily available funds of any given currency held by the Settlement Provider or Resident Central Bank for the benefit of a Custodian, Sovereign Government or Resident Bank.

“External Securities Account” as used in the present application refers to a record or set of records maintained by a Settlement Provider to keep track of certain financial securities held by the Settlement Provider for the benefit of a Custodian, Sovereign Government or Resident Bank.

“Hard Currency Bond” as used in the present application refers to a debt security issued by a Sovereign Government, such as global bond, and which are denominated in currencies that are foreign to that Sovereign Government. An example of such hard currency is U.S. dollars or Euros. In the case of Hard Currency Bonds which are denominated in U.S. dollars, those Hard Currency Bonds are typically deposited with a U.S. depository institution such as the Depositary Trust Company (TRADEMARK), and debt service funds arising from such Hard Currency Bonds are deposited with a U.S. depositary.

“Internal Cash Account” as used in the present application refers to a record or set of records stored by the computer system described by the present application to keep track of the positions of various clients of the Custodian in readily available funds of a given currency.

“Internal Securities Account” as used in the present application refers to a record or set of records stored by the computer system described by the present application to keep track of the positions of various clients of the Custodian in certain financial securities.

“Issuer” as used in the present application refers to an entity, usually a sovereign government or related entity of a foreign emerging market country, which issues a Hard Currency Bond, and/or a LITE Security for the benefit of Resident Banks.

“Linked Issuance Through Exchange Security” or “LITE Security” as used in the present application refers to a synthetic form of debt security created through the use of the present invention, which is the combination of (1) a Cross Currency Swap which gives the holder of the LITE Security the right to receive hard currency payments (linked to a particular Hard Currency Bond) and the obligation to pay local currency payments (linked to a particular Local Currency Bond) and (2) the right to receive local currency payments under a Local Currency Bond that is linked to a particular Hard Currency Bond. The LITE Security may be issued by a Sovereign Government, and its cash flows are structured to match the cash flows of a specific Hard Currency Bond, which is being surrendered for the LITE Security. The LITE Security is part of an exchange whereby the holder of the Hard Currency Bond can receive a LITE Security in exchange for tendering the Hard Currency Bond to its Sovereign issuer, and at some time thereafter, exchange the LITE Security received for the original Hard Currency Bond.

“Local Currency Bond” as used in the present application refers to a debt security issued by a Sovereign Government and which are denominated in the currency that is local to that Sovereign Government, but whose value may be linked to a corresponding Hard Currency Bond.

“Master Agreement” as used in the present application refers to an agreement or sets of agreements among parties which include the Sovereign Government and Resident Bank(s) to exchange Hard Currency Bonds and LITE Securities between the Sovereign Government and Resident Bank(s), and/or vice-versa.

“Resident Central Bank” as used in the present application refers to the central bank or monetary authority which operates in the country of the Sovereign Government and which sells hard currency for local currency or vice-versa.

“Resident Bank” as used in the present application refers to a banking institution charted by a Resident Central Bank of a foreign country, which owns or desires to own a hard-currency denominated debt instrument issued by the Sovereign Government.

“Settlement Provider” as used in the present application refers to a company such as Depositary Trust Company (TRADEMARKED), Euroclear (TRADEMARKED) or Clearstream (TRADEMARKED) which provides clearing and settlement services to investors for securities such as Hard Currency Bonds. The Settlement Provider may be one company or a group of companies working together to provide clearing and settlement services to buyers and sellers of securities.

“Sovereign Government” or “Sovereign” as used in the present application refers to the national government of a foreign country, typically an emerging market country. When used in the context of an issuer of debt securities such as the Hard Currency Bond, “Sovereign Government” can include the central bank of that foreign country.

“Trustee” as used in the present application refers to the manager of a trust or any special purpose entity established for the benefit of the Resident Banks outside the country of the Sovereign for purposes of entering into the Master Agreement involving the investment in LITE Securities.

### BRIEF DESCRIPTION OF THE DRAWINGS

FIG. 1 shows the exchange of financial instruments between the Sovereign Government and the Resident Bank(s);

FIG. 1b shows liquidity using methods in the prior art;

FIG. 1c shows liquidity using the present invention;

FIG. 2 shows the cash flows of the original asset, which is the global bond (i.e. Hard Currency Bond) and the cash flows derived from the LITE Security, which is the asset to substitute for the Hard Currency Bond;

FIG. 3 shows the set-off of local currency receivables of the Resident Banks from the Local Currency Bond against the local currency payables of the Resident Banks under the Cross Currency Swap;

FIG. 4a shows the prior art on how the Sovereign Government services the prior-art Hard Currency Bond that is owned by a Resident Bank;

FIG. 4b shows the present invention on how the Sovereign Government normally uses the cash flow of the Hard Currency Bond to service the LITE Security owned by the Resident Bank;

FIG. 4c shows the present invention on how the Sovereign Government is able to service the LITE Security independent of the cash flow of the Hard Currency Bond;

FIG. 4d shows the present invention on how the Sovereign Government is able to service the LITE Security using local currency;

FIG. 5 shows the differences in the credit risk between a Hard Currency Bond and a LITE Security;

FIG. 6 shows the flow chart to be performed by the issuer of the LITE Security;

FIG. 7 shows the flow chart to be performed by the investor of the LITE Security FIG. 7a shows the flow chart to be performed by the investor of the prior-art Hard Currency Bond;

FIG. 8a shows the present invention during a no-default scenario (step 1);

FIG. 8b shows the present invention during a no-default scenario (step 2);

FIG. 9a shows the present invention during a default scenario (step 1);

FIG. 9b shows the present invention during a default scenario (step 2);

FIG. 10 shows the computer system and communications link of the present invention;

FIG. 11 shows a flow chart of the main program;

FIG. 12 shows a flow chart of the paying agency subprogram;

FIG. 13 shows a flow chart of the exchange agency subprogram;

FIG. 14 shows an example form used to calculate the credit risk weight for a financial asset;

FIG. 15 shows an example form used to calculate the credit risk weight for an exchange contract;

FIG. 16 shows an example of a form used to calculate the specific risk portion of the market risk weight; and

FIG. 17 shows an example of a form used to calculate the general market risk portion of the market risk weight.

### DETAILED DESCRIPTION OF THE DRAWINGS

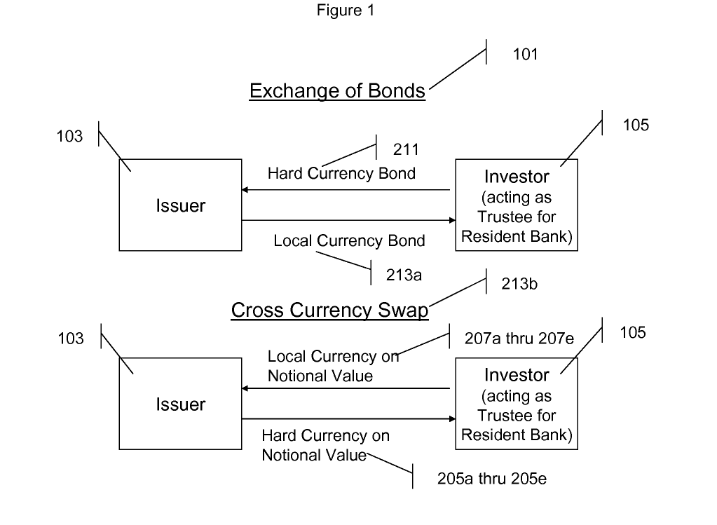

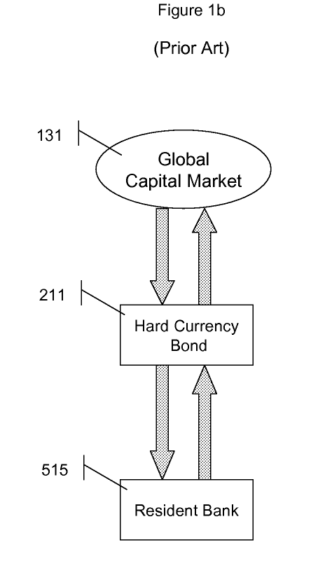

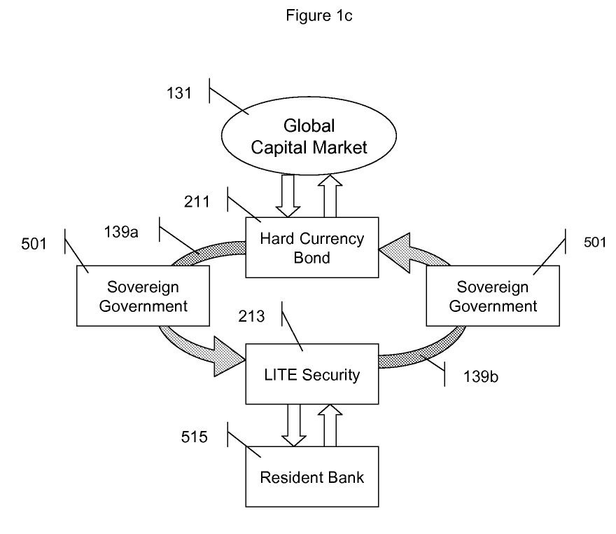

### FIG. 1:

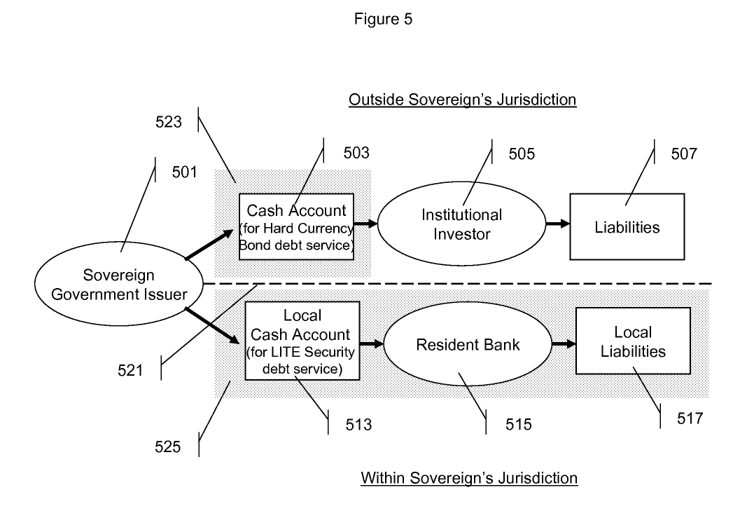

FIG. 1 shows the exchange of financial instruments between Issuer 103, which may be Sovereign Government 501 in FIG. 5, and investor 105 pursuant to a Master Agreement between Issuer 103 and investor 105. The transactions shown in FIG. 1 may refer to the first set of transactions to be executed under such Master Agreement governing the transaction shown in FIG. 1. Transaction 101 refers to the exchange of bonds, specifically Hard Currency Bond 211 for Local Currency Bond 213a. For Issuer 103 the exchange of bonds represents an exchange of liabilities whereby it receives Hard Currency Bond 211 and issues Local Currency Bond 213a. For investor 105, the exchange of bonds shown in FIG. 1 is an exchange of assets. Investor 105 relinquishes its ownership of Hard Currency Bond 211 in exchange for receiving ownership of Local Currency Bond 213a.

Hard Currency Bond 211 may already exist at the time of the exchange and if so, it is Local Currency Bond 213a that will have to be structured at the time of transaction 101. The term of Local Currency Bond 213a may be set to equal the remaining term of Hard Currency Bond 211. The two bonds could be made coterminous. The coupon payments due under Local Currency Bond 213a may coincide with the coupon payments due under Hard Currency Bond 211. Investor 105 may also accept a lower value for the coupon of Local Currency Bond 213a compared to the coupon of Hard Currency Bond 211 because the former carries a lower credit risk weight for purposes of calculating regulatory capital adequacy ratios. Hard Currency Bond 211 and Local Currency Bond 213a may both be structured with bullet payments. LITE Security 213 to be received by investor 105 in transaction 101 is comprised of Local Currency Bond 213a, local currencies 207a through 207e, and hard currencies 205a through 205e.

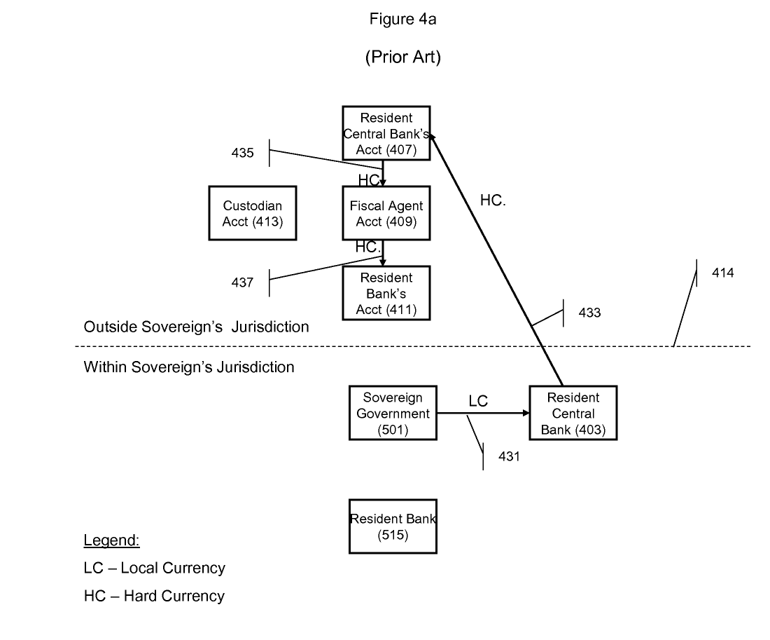

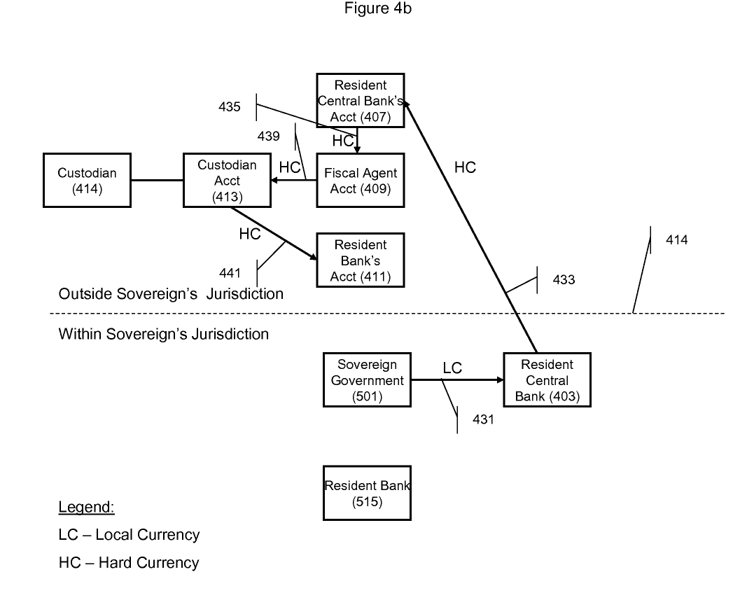

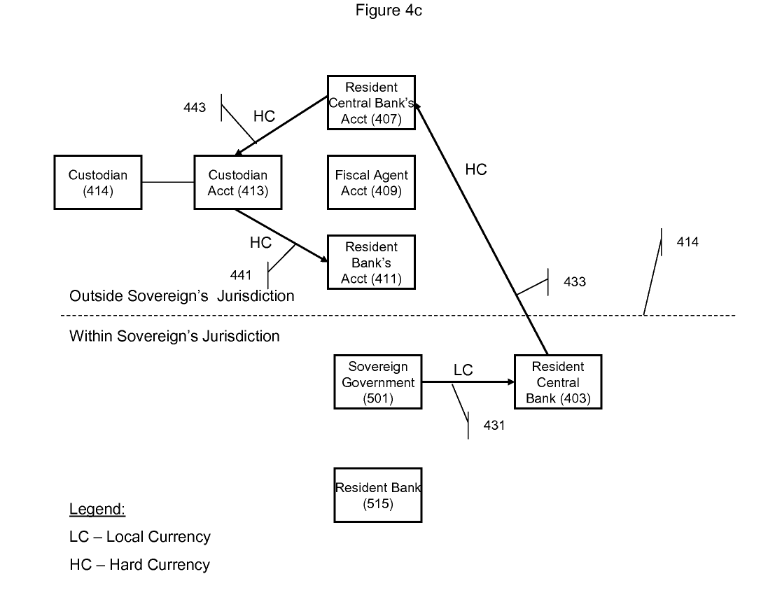

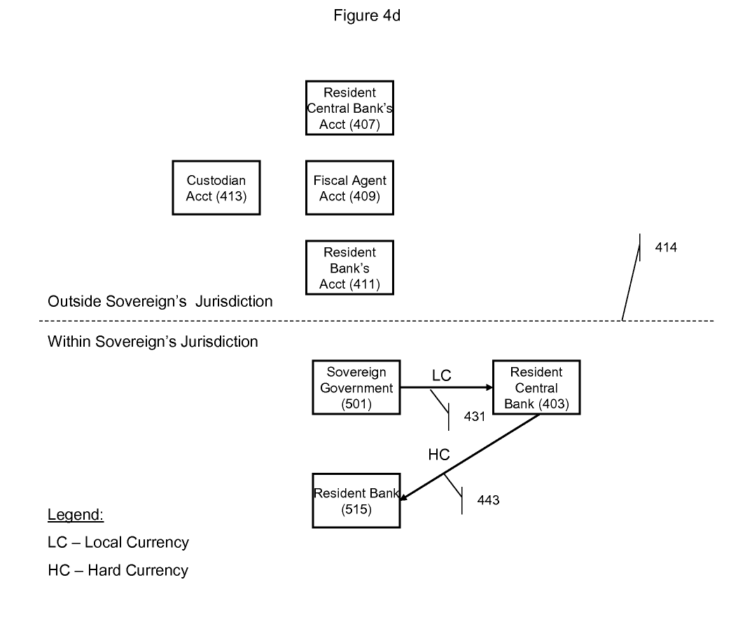

A method to determine the coupon payments and the principal payment due under Local Currency Bond 213a would be to dynamically link the value of the local currency payments of coupon and principal due under Local Currency Bond 213a to the coupon and principal due under the corresponding Hard Currency Bond 211. This can be accomplished by referring to the foreign exchange rate offered by Resident Central Bank 403 in FIG. 4b, which can change often, and which can then be used to calculate the value of the payments under Local Currency Bond 213a from that of Hard Currency Bond 211. During any period t the coupon and principal payments under Local Currency Bond 213a can be set as follows:

C_{LCB,t}=ERₜ×C_{HCB,t}

Where:

C_{LCB,t} the cash flow representing interest and/or principal due under Local Currency Bond 213a during period t;

ERₜ the floating rate exchange rate during period t quoted by Resident Central Bank 403; and

C_{HCB,t} the cash flow representing interest and/or principal due under Hard Currency Bond 211 during period t.

The Basel international capital standards for banks define that credit risk weights for a derivative contract such as a Cross Currency Swap 213b to be equal to the sum of two calculations. The first calculation is the replacement cost of Cross Currency Swap 213b. If this is a negative value, which means that the value of the remaining payables under Cross Currency Swap 213b is greater than the value of the remaining receivables under Cross Currency Swap 213b, then the replacement cost of Cross Currency Swap 213b is equal to zero.

There is also a second calculation to determine a component of the credit risk weight, referred to the add-on weight, set by a table published by the banking supervisory authority such Resident Central Bank 403. The add-on weight is minimized by frequently resetting the terms of Cross Currency Swap 213b so that its replacement cost is practically always equal to zero. It is therefore advantageous to investor 105 to have frequent resets of the terms of Cross Currency Swap 213b so that the replacement cost and the add-on weight will be minimized. The terms of Local Currency Bond 213a will also have to be adjusted during such reset dates because the receivable stream of investor 105 under Local Currency Bond 213a is set to equal the local currency payment stream 207a through 207e under Cross Currency Swap 213b.

Turning now to Cross Currency Swap 213b in FIG. 1, Issuer 103 and investor 105 enter into Cross Currency Swap 213b which will commit Issuer 103 to pay investor 105 the hard currency amounts based on the cash flows expected from Hard Currency Bond 211. In turn, investor 105 will commit to pay Issuer 103 the equivalent amounts in local currency based on the notional value of Cross Currency Swap 213b, which is linked to the principal amount of Hard Currency Bond 211.

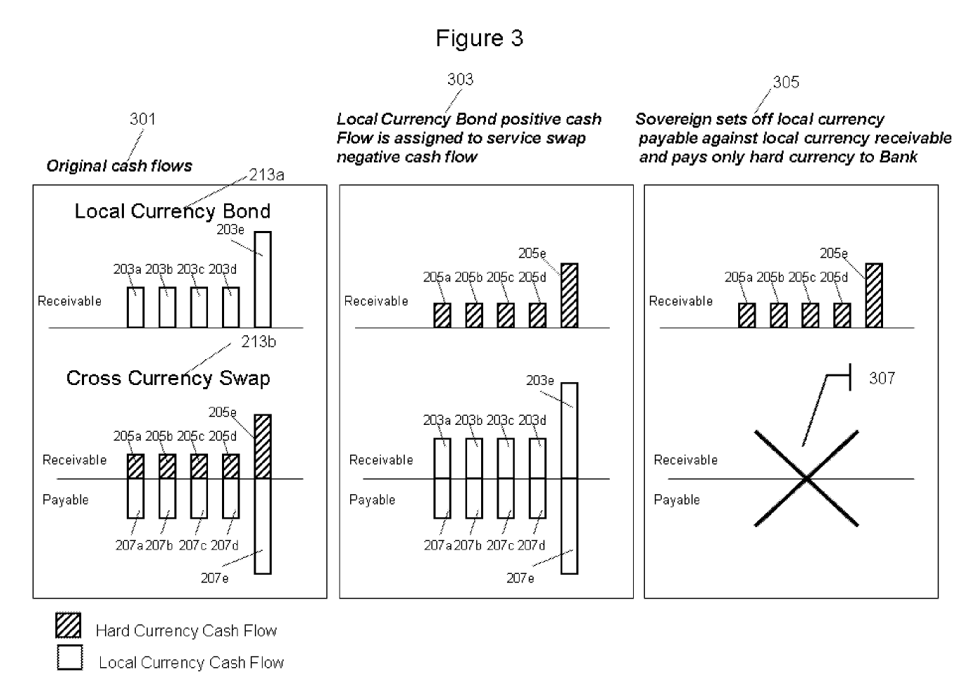

LITE Security 213, which is comprised of Local Currency Bond 213a and Cross Currency Swap 213b, is accounted for financial statement purposes as a single hard currency asset by investor 105, and as a single hard currency liability by Issuer 103. Under international accounting standards (IFRS), there is no need for investor 103 (or its beneficiary Resident Bank 515) which holds LITE Security 213 to record a local currency receivable under Local Currency Bond 213a or to record a local currency payable under Cross Currency Swap 213b. The avoidance of local currency accounting entries is accomplished by a requirement for the parties to set off local currency payables against local currency receivables which is explained in FIG. 3.

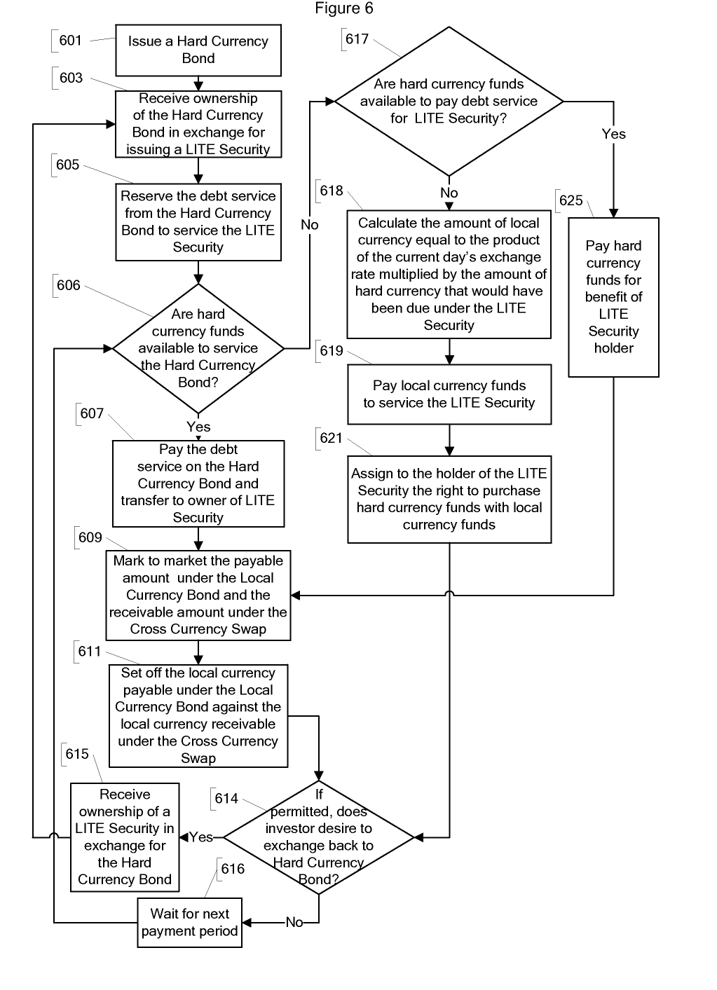

Although not shown in FIG. 1, an additional form of consideration that may be contained in LITE Security 213 is the assignment to investor 105 of the right to purchase hard currency from Resident Central Bank 403. This right is shown at step 621 of FIG. 6.

### FIG. 1b:

FIG. 1b shows how investor 105, such as Resident Bank 515, is able to buy and sell Hard Currency Bond 211, in global capital market 131. Global capital market 131 refers to the cooperation of buyers and sellers, market makers, and settlement and clearing service providers from several national capital markets so that demand from one national market can be satisfied by supply from another national market, and vice versa. Many sovereign governments, especially those from emerging market countries, have issued global bonds, like Hard Currency Bond 211, in order to sell to investors which reside in those various countries which participate in global capital market 131. Many resident banks like Resident Bank 515 also participate in global capital market 131 to obtain Hard Currency Bond 211 for investment. Resident Bank 515 may purchase Hard Currency Bond 211 when they are initially offered by its sovereign issuer or through a secondary purchase from a previous owner. Global capital market 131 exists to provide the greatest number of buyers and sellers for securities that are traded in it. Liquidity for those securities is maximized, which is important in minimizing the bid-and-ask spreads for those securities.

### FIG. 1c:

FIG. 1c shows an overview of how the present invention is able to create a new security, referred to as LITE Security 213, which Resident Bank 515 prefers to hold than Hard Currency Bond 211, without significantly affecting the ability of Resident Bank 515 to buy and sell in global capital market 131. Unlike Hard Currency Bond 211, LITE Security 213 may be governed by the issuer's own laws and adjudicated in the issuer's own courts. This is one reason why Resident Bank 515 may prefer LITE Security 213 to Hard Currency Bond 211. LITE Security 213 is governed through its own legal system.

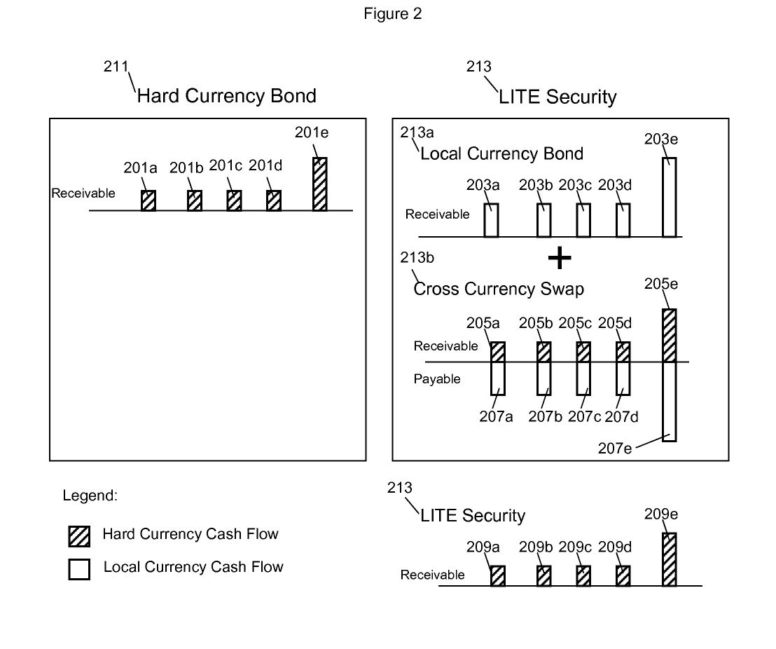

The present invention shown in FIG. 1c is made possible by the participation of the issuer of LITE Security 213, which is Sovereign Government 501. When Resident Bank 515 desires to purchase LITE Security 213, it first obtains control of Hard Currency Bond 211 from global capital market 131. Resident Bank 515 then delivers Hard Currency Bond 211 to Sovereign Government 501 causing Sovereign Government 501 to issue LITE Security 213 to Resident Bank 515. This transaction is shown by the curved arrow 139a. Unlike the usual case in the prior art when an issuer such as Sovereign Government 501 reacquires its own debt securities, Sovereign Government 501 does not retire Hard Currency Bond 211. Despite the co-existence of two debt securities, namely Hard Currency Bond 211 and the corresponding LITE Security 213, there is no double counting of debt stock for Sovereign Government 501 under international accounting standards. As will be explained in FIG. 2, the cash flows of the LITE Security 213 are linked to the cash flows of Hard Currency Bond 211 to such an extent that these cash flows may be viewed as mirror images of each other. Thus, Sovereign Government 501 can conveniently utilize the debt service cash flows of Hard Currency Bond 211 to satisfy the debt service requirements for LITE Security 213.

At some later time when Resident Bank 515 wishes to sell its investment in LITE Security 213, Resident Bank 515 engages in the transaction shown as curved arrow 139b, whereby the transaction shown at curved arrow 139a is reversed. This time Sovereign Government 501 (which is the same Sovereign Government 501 in curved arrow 139a but acting in a different transaction) receives ownership of LITE Security 213 and delivers Hard Currency Bond 211 which it received and held since transaction shown as curved arrow 139a.

The effect of the revolving exchange of securities with Sovereign Government 501 at transactions shown by curved arrow 139a and curved arrow 139b, as made possible through the use of the present invention, is that global capital market 131 perceives Resident Bank 515 as a market participant, just as Resident Bank 515 was a market participant in the prior art shown in FIG. 1b. Thus, the benefits of LITE Security 213 to Sovereign Government 501 and Resident Bank 515, as will become more clearly explained in the descriptions that follow, can be achieved with minimal impact on the liquidity of Hard Currency Bond 211 being bought and sold in global capital market 131, as was the practice in the prior art, because of demand from Resident Bank 515.

### FIG. 2:

Flows 201a, 201b, 201c, 201d and 201e show the hard currency cash flow due under Hard Currency Bond 211 that can be exchanged for LITE Security 213. FIG. 2 shows the relationship of the cash flows from Hard Currency Bond 211 and how these cash flows are related to those in the underlying components that comprise LITE Security 213. All the cash flows shown in FIG. 2, whether receivable or payable, are from the point of view of the holder (i.e. a Resident Bank) of Lite Security 213. From the point of view of the Issuer which is Sovereign Government 501 in FIG. 1, a receivable shown in FIG. 2 would be a payable and a payable shown in FIG. 2 would be a receivable. Cash flow 201 e is larger than cash flows 201 a to 201d occurring before cash flow 201e because cash flow 201e includes the payment of principal which is typically due at the maturity of a bullet-type bond. Hard Currency Bond 211 shown in FIG. 2 has a bullet amortization.

The following is the way that the cash flows 203a, 203b, 203c, 203d and 203e of Local Currency Bond 213a component of LITE Security 213 may be calculated. At any day when the local currency payment is due under Local Currency Bond 213a, the amount of local currency payment that would be due is based on the amount of hard currency funds that would have been due under Hard Currency Bond 211. Therefore, on the day that cash flow 203a is due, the amount due would be the product of that day's exchange rate multiplied by hard currency cash flow 201a. Similarly, on the day when local currency payment 203b is due, the amount of local currency that would be due would be that day's exchange rate multiplied by hard currency payment 201b. In similar fashion, any local currency payment such as local currency payments 203c, 203d, and even 203e, which contains a return of principal, can be calculated by multiplying the exchange rate on that day with the corresponding amount in hard currency that would have been due under Hard Currency Bond 211.

One leg of Cross Currency Swap 213b may simply be a mirror image of the cash flows pertaining to Hard Currency Bond 211 and the other leg of Cross Currency Swap 213b may simply be the cash flows pertaining to Local Currency Bond 213a where the right of Resident Bank 515 to receive hard currency payments from Cross Currency Swap 213b such as amounts 205a through 205e are equal and coincident to amounts 201 a through 201 e, while the obligation of Resident Bank 515 to pay local currency payments 207a through 207e are equal and simultaneous to amounts 203a to 203e of Local Currency Bond 213a.

Cross Currency Swap 213b is different from the usual cross currency swap commonly utilized in the prior art. The prior-art cross currency swap is usually just a stream of receivables in one currency and payables in another currency, with amounts due under either currency being predefined and fixed at the inception of the cross currency swap. Cross Currency Swap 213b comprising LITE Security 213, on the other hand, may be more accurately described as a series of future (also called “forward”) spot foreign exchange transactions, with dates coincident with the payment dates under Local Currency Bond 213a, whose payment dates, in turn, are coincident with the scheduled payments under Hard Currency Bond 211. Because the exchange of currencies under Cross Currency Swap 213b is based on the future “spot” exchange rate, the amount of the receivable flow and the amount of the payable flow cannot be ascertained at any time before the date of the actual exchange of currencies, which is unlike most of the cross currency swaps that are commonly used in the financial markets today.

After summing the positive and negative cash flows of LITE Security 213 composed of Local Currency Bond 213a and Cross Currency Swap 213b, the net result is hard currency cash flow such as cash flows 209a, 209b, 209c, 209d and 209e. This hard currency net cash flow from LITE Security 213 is a mirror image of cash flows 201a to 201e of Hard Currency Bond 211. Therefore, from a cash flow perspective, holding LITE Security 213 is equal to holding Hard Currency Bond 211. However, the credit risk weights under Basel II for the two assets can be very different. Specifically, more regulatory capital will be required to hold Hard Currency Bond 211 (if the external credit rating of Hard Currency Bond 211 is lower than AA-, as is the case for most emerging market countries) than will be required to hold LITE Security 213 if the components of LITE Security 213, specifically Local Currency Bond 213a and Cross Currency Swap 213b, are effectively assigned the credit risk weights prescribed by Basel II. Furthermore, since LITE Security 213 is more capital efficient to own for a bank under Basel II compared to Hard Currency Bond 211, Resident Bank 515 may be willing to share with Sovereign Government 501 the economic benefits of LITE Security 213 in the form on an upfront fee, a recurring fee or a coupon payment rebate, all of which effectively reduce the cost of Sovereign Government 501.

Local Currency Bond 213a component and Cross Currency Swap 213b component of LITE Security 213 are to be bundled together so that the two components have to be transferred or sold as one package. Cross Currency Swap 213b component cannot be stripped away or traded separately from LITE Security 213. For this reason, Cross Currency Swap 213b may be considered an “embedded derivative” in LITE Security 213 under both IAS 39 and FASB 133.

Flows 201a through 201e represent hard currency flows from a natural hard currency debt claim wherein the nature of the debt contract requires payment in hard currency. Flows 205a through 205e, although denominated in foreign currency, do not represent debt claims but rather claims arising from a foreign exchange contract which is executory in nature. Flows 203a through 203e represent the debt claim present in LITE Security 213 but these flows are denominated in local currency. Thus, LITE Security 213 does not have natural hard currency debt cash flows, but only synthetic hard currency debt cash flows 209a through 209e after the natural local currency debt cash flows have been converted to hard currency cash flows because of the operation of Cross Currency Swap 213b.

### FIG. 3:

FIG. 3 shows how local currency flows comprising LITE Security 213 are extinguished or set off against each other. The extinguishment or set-off is important so that LITE Security 213 can be accounted for financial statement reporting purposes as an asset which is 100% denominated in hard currency. From point of view of Resident Bank 515, it would be beneficial to maintain the same accounting status for LITE Security 213 as applied to Hard Currency Bond 211. Without extinguishment or set-off, Local Currency Bond 213a combined with Cross Currency Swap 213b could require accounting for two financial transactions—a local currency asset and a derivative transaction which would involve accruals in two different currencies: local currency for Local Currency Bond 213a component of the LITE Security and hard currency for Cross Currency Swap 213b component of the LITE Security. Booking local currency transactions could be a problem for resident banks which have regulations restricting the resident bank from engaging in local currency transactions. To avoid these problems, the terms of LITE Security 213 provide an extinguishment, in accounting terms, of the local currency flows.

In box 301, flows 203a through 203e show the cash flows of Local Currency Bond 213a while Cross Currency Swap 213b cash flows are represented by flows 205a through 205e for the hard currency receivables due to Resident Bank 515 under Cross Currency Swap 213b and by flows 207a through 207e as the local currency payables due from Resident Bank 515 under Cross Currency Swap 213b. As shown by box 303, the local currency receivables from Local Currency Bond 213a such as flows 203a through 203e exactly match the quantity and timing of the local currency payables shown underneath it, such as flows 207a through 207e referring to a payable leg of Cross Currency Swap 213b.

Finally, box 305 shows that all of the local currency flows, comprising local currency payables such as flows 207a through 207e against local currency receivables such as flows 203a through 203e, are set off against each other leaving solely the hard currency flows 205a through 205e as the only expected stream of receivables for Resident Bank 515 which holds LITE Security 213. Under the assumption that LITE Security 213 will be performed by Sovereign Government 501 as promised, the only receivables that will remain, after the set-off of local currency cash flows, are denominated in hard currency. This fact allows the LITE Security 213 to be accounted for Resident Bank 515 as a hard currency denominated asset. Similarly, Sovereign Government 501 can report LITE Security 213 as a hard currency denominated liability on its financial statements for the similar reason that Resident Bank 515 which holds LITE Security 213 can report it as a hard currency denominated asset. This is because the only set of flows that Sovereign Government 501 has to disburse to service LITE Security 213, after the set-off of local currency flows against each other, is a set of hard currency flows 205a through 205e.

If Sovereign Government 501 should default on the delivery of hard currency to Resident Bank 515 under Cross Currency Swap 213b, then the ability to set off local currency payments against each other may be lost (such as flows 203a through 203e against flows 207a through 207e), and Resident Bank 515 may need to account for remaining local currency receivable (203a through 203e) from Sovereign Government 501, while Sovereign Government 501 may have to account for a local currency payable to Resident Bank 515.

### FIG. 4a:

FIG. 4a shows how Hard Currency Bond 211 in FIG. 2 is normally serviced in the prior art. Elements below broken line 414 represent elements operating within the jurisdiction of Sovereign Government 501 while elements above broken line 414 represent elements operating outside the jurisdiction of Sovereign Government 501. Servicing refers to the method by which the issuer of Hard Currency Bond 211, in this case, Sovereign Government 501 pays for the scheduled coupon payments (i.e. interest payments) and principal payments under Hard Currency Bond 211 that it has issued. In this example, Sovereign Government 501, the issuer of Hard Currency Bond 211, does not yet own the hard currency that will be required to service Hard Currency Bond 211. The hard currency is purchased by Sovereign Government 501 from Resident Central Bank 403 with local currency based on the prevailing exchange rate offered by Resident Central Bank 403. The foreign exchange purchase transaction is shown as arrow 431. Resident Central Bank 403 in turn transfers the hard currency purchased by Sovereign Government 501 to the country where the bonds are issued, for example, the United States. The transfer of hard currency funds by Resident Central Bank 403 is shown by an instruction sent to the depositary bank where Resident Central Bank 403 deposits hard currency funds outside the country of Sovereign Government 501, such as bank account 407 which is owned by Resident Central Bank 403. The transfer may be performed by a payment instruction message sent by Resident Central Bank 403 to the depositary bank where account 407 has been established. The message is usually sent electronically such as through the SWIFT (TRADEMARK) messaging system, or alternatively through telex or through paper documents such as a paper check.

Upon receipt of the payment instruction message, the depositary bank, where account 407 is established will send the hard currency funds by debiting account 407 of Resident Central Bank 403 and transfer the hard currency funds to the benefit of the fiscal agent (not shown), which owns fiscal agent account 409, which is responsible for distributing the hard currency funds to the various holders of Hard Currency Bond 211. In this example shown in FIG. 4a, Resident Bank 515 is a holder of Hard Currency Bond 211 which has been issued by Sovereign Government 501. Resident Bank 515 also may own account 411 established with a depositary bank outside the country of Resident Bank 515. The hard currency funds that are transferred on behalf of Sovereign Government 501 are deposited by a third party, for example, a fiscal agent, which owns account 409, in account 411 of Resident Bank 515. The fiscal agent which owns account 409 is appointed by Sovereign Government 501 to distribute debt service payment to the holders of Hard Currency Bond 211, among other duties. Hard Currency Bond 211, since its is paid outside the country of Sovereign Government 501, require that Sovereign Government 501 or Resident Central Bank 403 possess sufficient hard currency to remit outside of the country of Sovereign Government 501 for the purpose of servicing Hard Currency Bond 211 in bank account 411 established outside the country of Sovereign Government 501.

The risk that Sovereign Government 501 will have insufficient hard currency so that it will be unwilling or unable to service Hard Currency Bond 211 is referred to as “sovereign default risk”, or as hard currency “debt moratorium” risk. This is an important distinction of the present invention over the prior art. The product of the present invention, LITE Security 213, can be serviced by Sovereign Government 501 even though neither Sovereign Government 501 or Resident Central Bank 403 has sufficient hard currency (that may be used as external payments to depositary banks located outside the country of Sovereign Government 501) available to service LITE Security 213.

### FIG. 4b:

FIG. 4b represents a method by which LITE Security 213 can be serviced by Sovereign Government 501. Elements below broken line 414 represent elements operating within the jurisdiction of Sovereign Government 501 while elements above broken line 414 represent elements operating outside the jurisdiction of Sovereign Government 501. In this case, LITE Security 213 is serviced indirectly through the cash flow generated by Hard Currency Bond 211. Resident Bank 515 receives Hard Currency Bond 211 in exchange for issuing LITE Security 213. As stated in the description of FIG. 4a, Sovereign Government 501 normally purchases hard currency funds with local currency funds, as shown by arrow 431, from Resident Central Bank 403 in order to service the hard-currency denominated obligations of Sovereign Government 501 such as Hard Currency Bond 211. Although not shown in FIG. 4b, Resident Central Bank 403 can accumulate the hard currency funds from balance-of-payment transactions of residents with non-residents. The accumulated hard currency of Resident Central Bank 403 serves as the international reserves of the country.

Resident Central Bank 403 is the source of the hard currency that will be needed to pay for the debt service for the entire series of bonds representing Hard Currency Bond 211, which have to be serviced by the fiscal agent. The bonds comprising this series include: (a) Hard Currency Bond 211 owned by Sovereign Government 501 through the exchange and the issuance of LITE Security 213 such as shown in FIG. 1c, and (b) Hard Currency Bond 211 which remain outstanding and which have not been exchanged for LITE Securities 213. As far as Sovereign Government 501 and Resident Central Bank 403 are concerned, they are following the same method of payment disbursement used in the prior art as shown in FIG. 4a to service both LITE Securities 213 and Hard Currency Bond 211 which have not been exchanged for LITE Securities and which remain outstanding. Consistent with the prior-art method shown in FIG. 4a, Resident Central Bank 403 sends instruction shown by arrow 433 to the depository bank where account 407 of Resident Central Bank 403 is established. The instruction shown by arrow 433 by Resident Central Bank 403 is to transfer the hard currency amount deposited at account 407 to the fiscal agent account 409. This transfer of hard currency from account 407 to fiscal agent account 409 is shown by arrow 435. By the transfer shown as arrow 439, the fiscal agent, which owns account 409, services Hard Currency Bond 211 by transferring funds deposited in fiscal agent account 409 to custodian account 413 owned by Custodian 414.

Because LITE Security 213 is linked to Hard Currency Bond 211, meaning that the hard currency cash flow from Hard Currency Bond 211 is approximately, if not exactly, equal to that of LITE Security 213 at any given period, the cash flow arising from the debt service received from Hard Currency Bond 211 and deposited in custodian account 413 is sufficient to service LITE Security 213. Through the instruction shown as arrow 441, Custodian 414 causes the hard currency funds in custodian account 413 to be transferred to account 411 of Resident Bank 515. In this way, Resident Bank 515 that owns LITE Security 213 is able to receive the same amount of hard currency in its bank account 411 as it would have received had Resident Bank 515 owned Hard Currency Bond 211 instead. The situation described in FIG. 4b shows that when there is no financial crisis (for example, a condition of debt moratorium or capital control) affecting Sovereign Government 501, LITE Security 213 is serviced in the same way that Hard Currency Bond 211 is serviced. In fact, the debt service for LITE Security 213 flows directly through Hard Currency Bond 211 owned by Sovereign Government 501. In the same way as in the prior art, Resident Bank 515 which holds LITE Security 213 is able to receive hard currency funds in its account 411 as it would have had had it owned Hard Currency Bond 211 instead of LITE Security 213.

### FIG. 4c:

FIG. 4c shows the situation in which LITE Security is being serviced directly by Sovereign Government 501 without using the cash flow from Hard Currency Bond 211 to service LITE Security 213 as was shown in FIG. 4b. Elements below broken line 414 represent elements operating within the jurisdiction of Sovereign Government 501 while elements above broken line 414 represent elements operating outside the jurisdiction of Sovereign Government 501. In the situation shown in FIG. 4c, Sovereign Government 501 services LITE Security 213 through Resident Central Bank 403. This is the case when Sovereign Government 501 needs to purchase its hard currency requirements from Resident Central Bank 403. Sovereign Government 501 uses local currency to purchase the hard currency, which transaction is shown by arrow 431. Resident Central Bank 403 then instructs its depositary bank located abroad, where bank account 407 is established, to transfer hard currency funds to custodian account 413. The transfer of hard currency funds from account 407 to custodian's account 413 is shown as arrow 443. Custodian 414 then uses these hard currency funds deposited in account 413 to service LITE Security 213 by causing hard currency funds deposited in account 413 to be transferred and deposited in account 411 of Resident Bank 515. The transfer of hard currency funds is shown as arrow 441. Thus, Sovereign Government 501 is able to continue servicing LITE Security 213 without relying on the cash flows generated by the corresponding Hard Currency Bond 211. This may be the method used by Sovereign Government 501 following default or debt moratorium affecting Hard Currency Bond 211, because the default or moratorium causes no cash flow to be generated by Hard Currency Bond 211.

The scenario shown in FIG. 4c assumes that Sovereign Government 501 defaults on external debt but does not default on either component of LITE Security 211, which are Local Currency Bond 213a and Cross Currency Swap 213b. Neither of the two components comprising LITE Security 213 may be considered to be hard currency denominated debt, as is Hard Currency Bond 211. Thus a debt moratorium affecting Hard Currency Bond 211 of Sovereign Government 501 would not normally or necessarily apply to LITE Security 213.

### FIG. 4d:

FIG. 4d shows how LITE Security 213 can be serviced despite there being a condition of default or debt moratorium that may be affecting the ability of Sovereign Government 501 to service debt denominated in hard currency, for example, all hard currency bonds. Elements below broken line 414 represent elements operating within the jurisdiction of Sovereign Government 501 while elements above broken line 414 represent elements operating outside the jurisdiction of Sovereign Government 501. LITE Security 213 is really two financial instruments packaged together. Neither of these two instruments, Local Currency Bond 213a or Cross Currency Swap 213b, may be considered by Sovereign Government 501 as part of a general debt moratorium on its hard currency debt because neither of these two instruments fall under the definition of hard currency debt. In the example shown in FIG. 4d, Sovereign Government 501 which has issued LITE Security 213 has not defaulted on either Local Currency Bond 213a or Cross Currency Swap 213b despite having a condition of default or debt moratorium imposed on Hard Currency Bond 211. In contrast to LITE Security 213 which is normally issued under the law of Sovereign Government 501, Hard Currency Bond 211 is normally issued by Sovereign Government 501 in a jurisdiction outside it, for example, in the United States under New York law.

As has been shown in the prior art diagram in FIG. 4a, the agreement or bond indenture which defines the method by which Sovereign Government 501 is to repay Hard Currency Bond 211 usually requires that Sovereign Government 501 cause hard currency funds to be transferred to a fiscal agent (not shown) operating outside the country of Sovereign Government 501. The fiscal agent then causes the distribution of hard currency funds transferred by Sovereign Government 501 to the various accounts of the holders of Hard Currency Bond 211.

FIG. 4d shows how LITE Security 213 can be serviced differently by Sovereign Government 501 compared to the method shown in FIG. 4a, referred to in the previous paragraph. In this different method, Resident Bank 515 purchases hard currency funds from Resident Central Bank 403 using the local currency of Sovereign Government 501. This may be during a situation in which Sovereign Government 501 does not wish to purchase hard currency from Resident Central Bank 403. The debt service of LITE Security 213 by Sovereign Government 501 (more specifically the debt service under its Local Currency Bond 213a component) is made by Sovereign Government 501 depositing local currency funds at Resident Central Bank 403 for the account of Resident Bank 515 which is shown by arrow 431. At that point, Resident Bank 515 owns local currency and not hard currency. However, Resident Bank 515 may have the right to exchange local currency for hard currency with Resident Central Bank 403 as shown by step 621 in FIG. 6. The sale of hard currency for local currency is shown by the arrow 443 in which Resident Central Bank 403 credits the hard currency account of Resident Bank 515 with the amount of hard currency purchased by Resident Bank 515.

The hard currency credited to Resident Bank 515 by Resident Central Bank 403 is represented as a credit to the deposit account established with Resident Central Bank 403. The hard currency balances in this account with Resident Central Bank 403 do not represent hard currency funds which have to be transferred abroad and deposited with overseas bank accounts for as long as Resident Bank 515 does not withdraw such hard currency funds and transfer the funds overseas. However, without transferring of such hard currency funds to overseas accounts, Resident Bank 515 cannot use its hard currency balances deposited with Resident Central Bank 403 outside their country. The ability of Resident Central Bank 403, or Sovereign Government 501, to continue to pay debt service for LITE Security 213 despite the fact that it has insufficient hard currency balances which can be transferred abroad, or despite there being a condition of debt moratorium affecting Hard Currency Bond 211, makes LITE Security 213 economically safer for Resident Bank 403 to own compared to Hard Currency Bond 211. This is because although Resident Central Bank 403 or Sovereign Government 501 have no hard currency funds that can be transferred or sent abroad (outside Resident Banks' country) to service Hard Currency Bond 211 (which by their terms have to be serviced abroad), LITE Security 213 can always be serviced by crediting hard currency to the account of Resident Bank 515 existing within Resident Central Bank 403. Thus, by using the method shown in FIG. 4d during a time when there are no hard currency funds to transfer abroad, in other words not enough or no international reserves, Resident Bank 515, is still able to receive debt service, whereas a holder of Hard Currency Bond 211 would not be able to receive debt service.

There is also no legal contractual obstacle for Sovereign Government 501 or Resident Central Bank 403 to service LITE Security 213 despite there being a condition of default under Hard Currency Bond 211. Unsubordinated and unsecured Hard Currency Bond 211 represent hard currency denominated debt, which is pari passu or which rank equally with other unsubordinated and unsecured hard-currency denominated debt of Sovereign Government 501. True hard currency debt is commonly defined as “debt for money borrowed in which the currency for repayment is in a currency that is different from the local currency” of Sovereign Government 501. Neither of the two separate financial instruments comprising LITE Security 213 (i.e. Local Currency Bond 213a and Cross Currency Swap 213b) fall under this definition of hard currency debt and would therefore not necessarily be covered by the pari passu or equal-rank provisions governing such hard currency debt issued by Sovereign Government 501.

Under the standard equal-rank provisions applicable to most sovereign governments' unsubordinated hard currency debt, the sovereign governments' local currency debt is usually excluded. Thus, such standard equal-rank provisions would not necessarily prohibit Sovereign Government 501 from servicing Local Currency Bond 213a, which is a component of the LITE Security 213, even while Sovereign Government 501 is in default of Hard Currency Bond 211. Similarly, Sovereign Government 501 may be able to service Cross Currency Swap 213b component of the LITE Security 213 even while being in default of Hard Currency Bond 211 because Cross Currency Swap 213b does not constitute a contract of debt but rather a contract of currency exchange.

### FIG. 5:

FIG. 5 shows how Hard Currency Bond 211 of FIG. 2 can have different risk characteristics for Resident Bank 515 compared to the risk characteristics of LITE Security 213. Sovereign Government 501 can service its debt securities, whether this is Hard Currency Bond 211 or LITE Security 213, by depositing payments for the account of the investor of that security. All of the elements above horizontal broken line 521 fall outside the jurisdiction of Sovereign Government 501, while all of the elements below horizontal broken line 521 fall within the jurisdiction of Sovereign Government 501.

As shown in FIG. 5, Sovereign Government 501 causes debt service payments to be deposited in cash account 503 for the benefit of investor 505, which is a foreign institutional investor, for example a foreign bank. Both cash account 503 and investor 505 are outside of the jurisdiction of Sovereign Government 501. Therefore, liabilities 507 of investor 503 are also outside the jurisdiction of Sovereign Government 501. This means that both the assets (such as cash account 503) and the liabilities such as liabilities 507 are governed by laws outside Sovereign Government 501.

If Sovereign Government 501 fails to service its obligation under Hard Currency Bond 211 by failing to deposit funds in account 503 of investor 505, this default event will not normally reduce or forgive liabilities 507 of investor 505. Liabilities 507 of investor 505 can arise for example as a deposit liability of investor 505, if investor 505 is a bank. Thus, the negative impact of a default by Sovereign Government 501 under an obligation such as Hard Currency Bond 211 (for which debt service would need to flow to account 503) will have to be absorbed by the capital of investor 505 because the impact of such default cannot be passed on to liabilities 507. In this case, the amount of capital possessed by investor 505 determines that the ability of investor 505 to absorb such risk of default, saving liabilities 507 from becoming economically impaired.

It is likewise possible that Sovereign Government 501 can default in making payments on LITE Security 213 whose debt service would normally flow to local cash account 513 that Resident Bank 515 owns. However, this case of Resident Bank 515 is different from that of investor 505 because the laws applicable to liabilities 517 of Resident Bank 515 can be created, amended, suspended or superseded by Sovereign Government 501 at will. Sovereign Government 501 can also influence the way such laws are enforced. This is because, by definition, the sovereign of any country is the source of all laws within that country. Sovereign Government 501 can modify law or applicable regulation within its own jurisdiction so that the impact of default under LITE Security 213, resulting in non-payment of funds to cash account 513, is passed on to local liabilities 517. Sovereign Government 501, for example, can apply capital control regulation uniformly across all deposit accounts within the jurisdiction of Sovereign Government 501. In that event, the ability of Resident Bank 515 to withdraw liquid funds from cash account 513 may be frozen by the then adopted law or regulation; however, a similar or reciprocal form of protection may be imposed on liabilities 517.

For example, capital control regulation, if imposed uniformly across the system within the jurisdiction of Sovereign Government 501, can have the similar impact on local liabilities 517 of Resident Bank 515 as it has on local cash account 513 of Resident Bank 515. In such situation, the depositor of Resident Bank 515 that owns local liabilities 517 cannot freely withdraw its deposit from Resident Bank 515, anymore than Resident Bank 515 can freely withdraw its deposit such as 513 (especially if such deposit is held at Resident Central Bank 403 or is held within the banking system governed by Resident Central Bank 403). Unlike institutional investor 505, Resident Bank 517 is naturally hedged against the risk of default of Sovereign Government 501 because Resident Bank 515 can pass on the risk of default to the depositors holding local liabilities 517. Thus Resident Bank 515 which holds LITE Security 213 needs less risk capital to deal with the credit risk of a default by Sovereign Government 501 than would investor 505 which holds Hard Currency Bond 211.

The situation of investor 505 which operates outside the jurisdiction of Sovereign Government 501 is quite different from that of Resident Bank 515. For investor 505, Sovereign Government 501 can do nothing to diminish the economic severity of liabilities 507 against investor 505 in the event of a default because liabilities 507 falls outside the country, jurisdiction and scope of influence of Sovereign Government 501. Thus investor 505 is more likely to experience a mismatch between the economic value of its assets and the economic cost of its liabilities in the case of a default by Sovereign Government 501. Accordingly, investor 505 needs capital to hedge against the risk from the mismatch.

Grey-marked area 525 indicates the scope of a restructuring that could accompany a sovereign default. A sovereign default is always a major event for any country because it affects practically every resident of that country. Often, such restructuring affects both the asset side and the liability side of the country's entire banking system. LITE Security 213 which is an asset of resident banks such as Resident Bank 515 during such a restructuring is less risky for those resident banks not because LITE Security 213 is less risky by itself, but rather because its risk can be coordinated with the risk facing the liability side represented by liabilities 517. The degree of correlation of the performance of LITE Security 213 with the performance of liabilities 517 provides a high degree of risk protection for Resident Bank 515 which invests in LITE Security 213. That degree of correlation is assured by national policies that Sovereign Government 501 is likely to adopt to protect its banking system from being severely impacted by an event as severe as a sovereign default.

In contrast, only the asset side (i.e. Hard Currency Bond 211) of foreign institutional investor 505 can be restructured following a sovereign default. The scope of the restructuring for non-residents is shown by grey marked area 523. Unlike area 525, which appears below area 523, the scope of the restructuring for foreign institutional investor 505 cannot reach its liabilities 507. Thus, foreign institutional investor 505 faces greater risks which cannot be passed along to its liability side. Therefore, investor 505 need more capital to absorb the economic impact of such risks.

### FIG. 6:

FIG. 6 shows the actions that the issuer of LITE Securities 213 in FIG. 2, which is Sovereign Government 501 in FIG. 5, can perform to practice the present invention. At step 601, Sovereign Government 501 issues Hard Currency Bond 211 shown in FIG. 2. Hard Currency Bond 211 is issued usually under the laws of a jurisdiction outside the territory of Sovereign Government 501, such as New York or London. Hard Currency Bond 211 issued at step 601 may be issued as a re-opening of an existing series of Hard Currency Bond 211 which are already traded in the market. In this case, the price and yield of Hard Currency Bond 211 to be issued at step 601 may be at, or close to, the prevailing market prices of such bonds underlying that existing series. On the other hand, Sovereign Government 501 may issue an entirely new series of Hard Currency Bond 211 at step 601.

At step 603, Sovereign Government 501 receives ownership of Hard Currency Bond 211 in exchange for issuing LITE Security 213 to the previous owner of Hard Currency Bond 211, which may be Resident Bank 515 in FIG. 5 on investor 105 in FIG. 1. As explained in FIG. 1, LITE Security 213 to be issued by Sovereign Government 501 at step 603 may be structured so that its cash flows, meaning the coupon payments and principal payments, are set to match, in currency and amounts, the corresponding cash flows of Hard Currency Bond 211 which Sovereign Government 501 is receiving in exchange for issuing LITE Security 213. Although Sovereign Government 501 receives ownership of Hard Currency Bond 211 at step 603, Sovereign Government 501 does not retire or cancel the instrument constituting Hard Currency Bond 211, or remove it from being managed by the fiscal agent, or subtract it from the principal value of the global note, if Hard Currency Bond 211 was issued in the form of a global note. However, under international generally accepted accounting standards, specifically IAS 39 and FASB 133, the non-retirement of Hard Currency Bond 211 and issuance of LITE Security 213 should not cause a double counting of the outstanding debt stock of Sovereign Government 501.

At step 605, Sovereign Government 501 reserves the debt service from Hard Currency Bond 211 as a source of cash flow to service LITE Security 213. This may be accomplished by Sovereign Government 501 establishing an account with a third party such as Custodian 414 shown in FIG. 4b, which may then hold the title of Hard Currency Bond 211 received by Sovereign Government 501. At step 603, Sovereign Government 501 may instruct Custodian 414 to collect the cash flows arising from Hard Currency Bond 211 that was received by Sovereign Government 501 at step 603. At step 605, Sovereign Government 501 may then instruct Custodian 414 to reserve the use of such cash flow from Hard Currency Bond 211 to service LITE Security 213 issued by Sovereign Government 501 at step 603. This use of cash flows from Hard Currency Bond 211 requires that Sovereign Government 501 will not cancel Hard Currency Bond 211 for as long as LITE Security 213 is outstanding and will continue to service Hard Currency Bond 211 although it is no longer counted as outstanding debt of Sovereign Government 501.

At step 606, Sovereign Government 501 determines whether it has enough hard currency available in order to service the next debt service payment due on Hard Currency Bond 211. Sovereign Government 501 may not have sufficient hard currency available because Sovereign Government 501 is experiencing a severe foreign exchange crisis. Or, Sovereign Government 501 may have enough hard currency but has reserved the use of that hard currency for other needs of the domestic economy that Sovereign Government 501 believes is more important than servicing Hard Currency Bond 211. Or, Sovereign Government 501 may have declared a state of moratorium on all of its hard currency debt so that making debt service to Hard Currency Bond 211 at that point would constitute a violation of equal rank or pari passu covenants imposed on Sovereign Government 501.

If the answer to test 606 is “yes”, meaning there is sufficient hard current available to service Hard Currency Bond 211, the process proceeds to step 607, where Sovereign Government 501 causes the debt service scheduled under Hard Currency Bond 211 to be paid, usually through a fiscal agent which has been appointed by Sovereign Government 501 for this task. Usually, Hard Currency Bond 211 received by Sovereign Government 501 at step 603 is just a portion of a larger outstanding issuance, referred to as a series of Hard Currency Bonds. Within step 607, Sovereign Government 501 may continue to service the entire series of securities encompassing Hard Currency Bond 211 that Sovereign Government 501 received from the investor 105 in step 603 in the same manner that Sovereign Government 501 was performing prior to the receipt of Hard Currency Bond 211 at step 603. At step 609, Sovereign Government 501 marks to market the local currency cash flows, as was explained in FIG. 1, comprising LITE Security 213 which Sovereign Government 501 issued at step 603.

Local Currency Bond 213a comprising LITE Security 213 issued at step 603 may have variable cash flows in local currency funds, which are periodically marked to market at step 609 as explained in the detailed description for FIG. 1. These local currency cash flows which are marked to market are (a) the local currency payable amount of Sovereign Government 501 under Local Currency Bond 213a and (b) the local currency receivable amount of Sovereign Government 501 under Cross Currency Swap 213b. The terms of Local Currency Bond 213a may require that the payment in local currency to be paid by Sovereign Government 501 during the relevant period be determined by multiplying a notional amount in hard currency by a reference exchange rate prevailing at that time. The product of multiplying the notional amount with the reference exchange rate is then multiplied by the coupon rate to calculate the amount of local currency payment due as coupon payment under Local Currency Bond 213a. The reference exchange rate may be the rate published by Resident Central Bank 403 in FIG. 4b at which Resident Central Bank 403 is willing to purchase or exchange the amount of hard currency that would have been due under the corresponding Hard Currency Bond 211. The effect of the mark to market is to require Sovereign Government 501 to pay the local currency equivalent of the hard currency cash flow which is being generated by Hard Currency Bond 211 which was surrendered to Sovereign Government 501 at step 603 in exchange for LITE Security 213.

At step 609 also, the local currency receivable of Sovereign Government 501 under Cross Currency Swap 213b may be adjusted by the same mark-to-market method as was performed for Local Currency Bond 213a and described in previous paragraph. As explained in FIG. 3, after the marking to market, the payable of Sovereign Government 501 in local currency under Local Currency Bond 213a may be exactly equal to the receivable of Sovereign Government 501 in local currency under Cross Currency Swap 213b component of LITE Security 213 issued at step 603. At step 611, Sovereign Government 501 sets off its local currency payables against its local currency receivables, according to the method explained in box 303 and box 305 of FIG. 3.

After step 611 is performed, the process proceeds to test 614 where Sovereign Government 501 determines whether investor 105 (or Resident Bank 515 as investor) in LITE Security 213 desires to exchange it for the corresponding Hard Currency Bond 211 that is owned by Sovereign Government 501. There may be conditions defined under LITE Security 213 that would prevent the investor of LITE Security 213 from exchanging it back to Hard Currency Bond 211, for example, if there is an existing event of default under LITE Security 213. Absent such conditions, investor 105 of LITE Security 213 would have the right to exchange it back for Hard Currency Bond 211 held by Sovereign Government 501.

If the answer to test 614 is “yes”, the process proceeds to step 615 where Sovereign Government 501 performs the exchange and delivers Hard Currency Bond 211 to the investor 105, while Sovereign Government 501 receives ownership of LITE Security 213. Since Sovereign Government 501 is the issuer of LITE Security 213, the execution of step 615 means that the outstanding liability of Sovereign Government 501 under LITE Security 213 is extinguished and is replaced by the outstanding liability under Hard Currency Bond 211. Sovereign Government 501 may then retire or cancel LITE Security 213. On the other hand, Sovereign Government 501 may decide to keep LITE Security 213 as a so-called “treasury bond” for re-assignment to another investor or Resident Bank (which could include the previous investor or Resident Bank) if step 603 is repeated in the future. Regardless of whether retired or kept as a treasury bond, the liability of Sovereign Government 501 represented by LITE Security 213 is extinguished at that point.

After step 615 is performed and Sovereign Government 501 reacquires LITE Security 213, Sovereign Government 501 will no longer have to perform the process shown at FIG. 6 for the next payment period with respect to that LITE Security 213. Therefore, the process reverts back to step 603 where Sovereign Government 501 again awaits an investor such as investor 105 to exchange a Hard Currency Bond for a LITE Security. The present invention allows Sovereign Government 501 and investor 105 (or Resident Bank 515) to exchange securities back and forth in step 603 and step 615 of FIG. 6. Although the process of paying debt service for this particular LITE Security 213 may have ended because LITE Security 213 has been reacquired by Sovereign Government 501 at step 615, Sovereign Government 501 may have to continue performing the process shown in FIG. 6 for other LITE Securities that may be outstanding.

Following step 615, the process proceeds to step 616, where Sovereign Government 501 waits for the next payment period under LITE Security 213. If there are no longer any payment periods remaining, this means that the relevant series of LITE Security 213 and the corresponding series of Hard Currency Bond 211 have already matured and Sovereign Government 501 will no longer have to perform the method shown in FIG. 6 with respect to the said series of LITE Security 213 or Hard Currency Bond 211. If the answer to test 614 is “no”, meaning that investor 105 of LITE Security 213 does not desire to exchange it for Hard Currency Bond 211, the process proceeds to step 616 where Sovereign Government 501 waits for the next payment period under LITE Security 213. After the next payment period has arrived, the process go backs to test 606, where it is to be determined again whether there are sufficient hard currency funds available to meet the next scheduled debt service for Hard Currency Bond 211.

Going back to test 606, if the result is “no,” meaning that hard currency funds are not available for debt service to be made under Hard Currency Bond 211, then test 617 is performed. There could be a number of reasons why the hard currency funds are not available to service Hard Currency Bond 211, as was explained in the previous paragraphs. Regardless of the reason for non-availability of hard currency funds, Sovereign Government 501 at test 617 determines whether there are any hard currency funds available that could be used to pay LITE Security 213. As explained elsewhere in the present application, the equal rank or pari passu conditions triggered by the non-payment of debt service under Hard Currency Bond 211 may not apply to LITE Security 213 because LITE Security 213 is not really comprised of any natural hard currency debt obligations. The hard currency nature of LITE Security 213 is synthetically created. Thus, it is possible to service LITE Security 213 although Hard Currency Bond 211 may be experiencing a payment default.

If the answer to test 617 is “yes,” then, at step 625, Sovereign Government 501 causes those available hard currency funds to be used to pay investor 515 of LITE Security 213. This is the payment method shown in FIG. 4c. After step 625, the process proceeds to step 609 which involve the actions that were explained in the previous paragraphs. Following step 609, the process proceeds along the same path that follow step 609 that was previously described.

On the other hand, if the answer to test 617 is “no,” Sovereign Government 501 will have to pay the local currency funds due under Local Currency Bond 213a component of the LITE Security 213 to investor 105. The answer to test 617 may be “no” because of a condition of capital control or foreign exchange control imposed in the country of Sovereign Government 501 that prevents Sovereign Government 501 from having hard currency funds available to service LITE Security 213. Step 618 is performed where Sovereign Government 501 calculates the value in local currency that would be equal in value to the hard currency payment that is the subject of test 617. Step 618 may be performed by obtaining the prevailing reference exchange rate at which Resident Central Bank 403 would be willing to sell the amount of hard currency that is the subject of test 617. The amount of local currency calculated at step 618 would then be equal to the product of that reference exchange rate multiplied by the hard currency amount referred to at step 618.

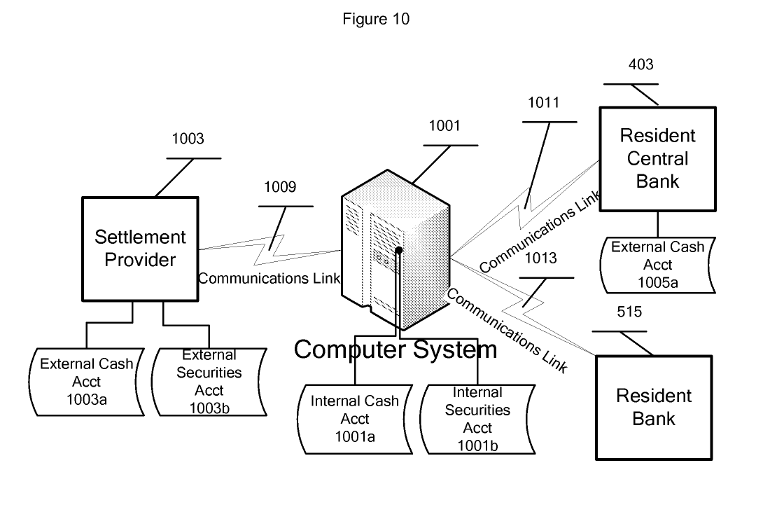

At step 619, Sovereign Government 501 pays the local currency amount calculated at step 618 which may be deposited in External Cash Account 1005a in FIG. 10 at Resident Central Bank 403 established for the benefit of investor 515. Following step 619, the process proceeds to step 621 where Sovereign Government 501 assigns its right to purchase hard currency funds for local currency funds for the benefit of investor 515 of LITE Security 213. Sovereign Government 501 may possess the right to purchase hard currency funds from Resident Central Bank 403, which right is assigned by Sovereign Government 501 to investor 515 of LITE Security 213 at step 621. (Although step 621 is shown following step 619, the order of performance of the two steps may be reversed in practice.)

After step 619 and step 621 have been performed, the process proceeds to test 614, where it is determined whether investor 105 desires to exchange LITE Security 213 for corresponding Hard Currency Bond 211. The steps that follow the result of test 614 have been explained in the previous above paragraphs.

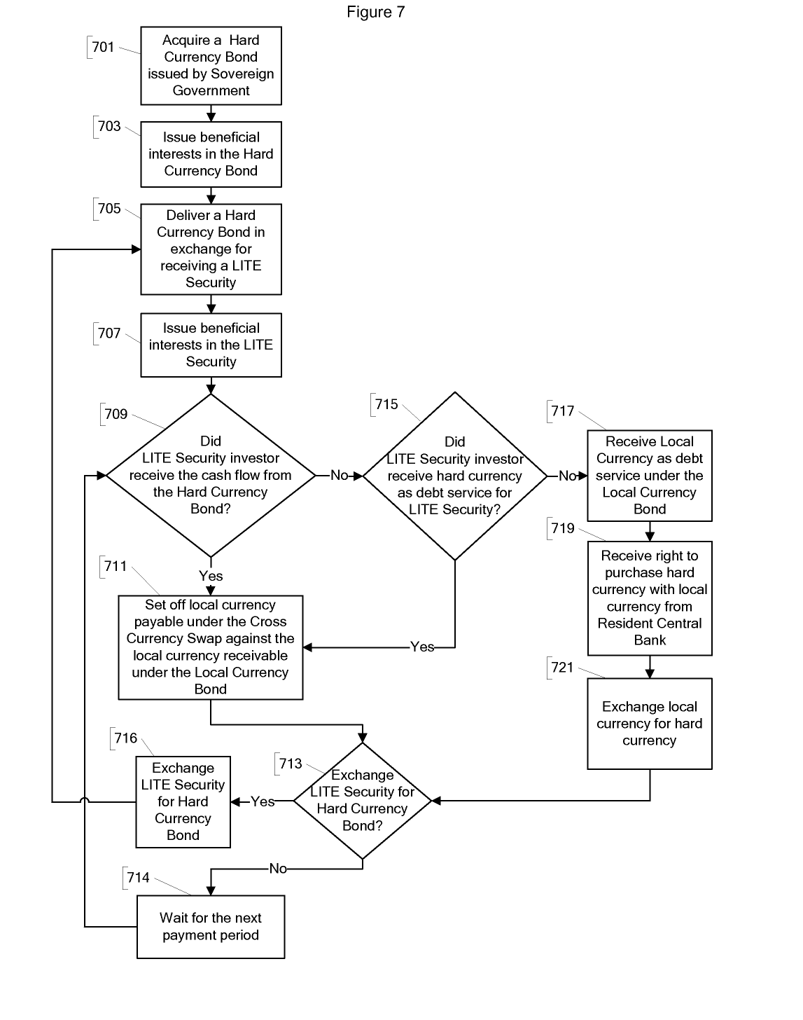

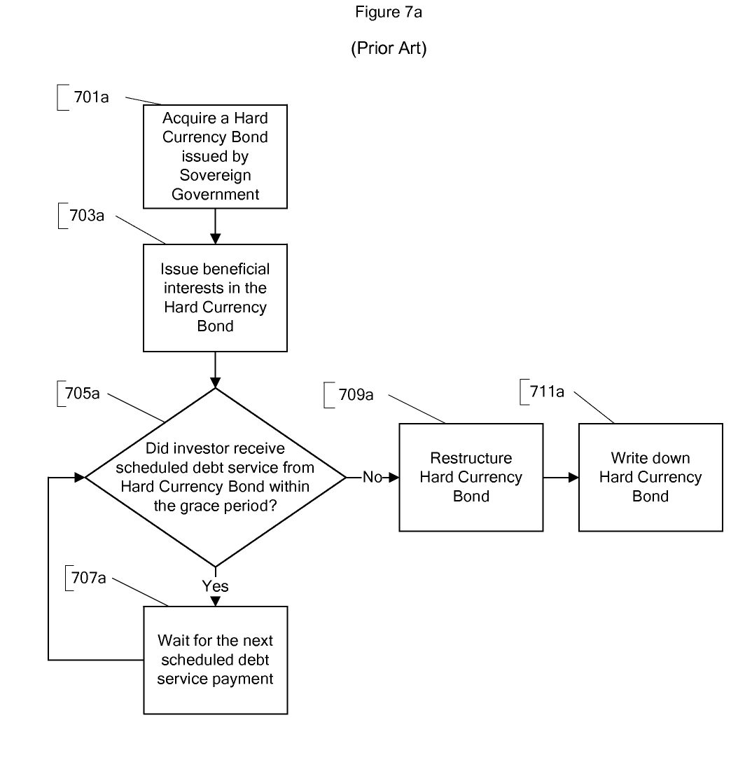

### FIG. 7:

FIG. 7 shows the flowchart of steps that an investor, or holder, of a LITE Security performs in order to practice the present invention. The investor 105 may be a Trustee acting on behalf of a Resident Bank 515. At step 701, investor 105 acquires Hard Currency Bond 211 issued by Sovereign Government 501. Hard Currency Bond 211 is the same Hard Currency Bond 211 issued at step 601 in FIG. 6 and may be purchased by investor 105 directly from Sovereign Government 501 or from the secondary market. At step 703, investor 105 may issue beneficial interests to Resident Bank 515, also known as beneficial ownership interests in Hard Currency Bond 211, which was received by investor 105 at step 701. At step 705, investor 105 delivers ownership of Hard Currency Bond 211 to Sovereign Government 501 in exchange for Sovereign Government 501 issuing or delivering LITE Security 213 to investor 105.

At step 707, investor 105 issues beneficial ownership interests in LITE Security 211 to Resident Bank 515. At test 709, investor 105 determines whether it has received cash flow generated by Hard Currency Bond 211 which it delivered to Sovereign Government 501 at step 701, and which may be held by Custodian 414 for the benefit of Sovereign Government 501. The cash flow received by investor 105 being tested at test 709 may be applied to interest and/or principal payments, scheduled to be paid by Sovereign Government 501 to investor 105 under LITE Security 211 that investor 105 owns.

If the answer to the inquiry performed at test 709 is “yes”, meaning the cash flow from Hard Currency Bond 211 was received by investor 105 as debt service for LITE Security 213, the process proceeds to step 711 where investor 105 sets-off the local currency payable under Cross Currency Swap 213b component of LITE Security 213 with the local currency receivable of investor 105 under Local Currency Bond 213a component of LITE Security 213. By performing step 711, investor 105 avoids the accounting recognition of a local currency payable and a local currency receivable arising from LITE Security 213. After step 711 is performed, the process proceeds to step 713 where investor 105 decides whether it wishes to exchange LITE Security 213 for the corresponding Hard Currency Bond 211 which is held by Sovereign Government 501. If the answer to test 713 is “yes”, meaning that investor 515 desires to exchange, investor 105 initiates the exchange by sending the instruction to execute the exchange to Sovereign Government 515 (or to Custodian 414, if acting on behalf of Sovereign Government 501). The exchange is performed at step 716 where investor 105 transfers LITE Security 213 to Sovereign Government 501 and receives Hard Currency Bond 211 from Sovereign Government 501. After step 716 is performed, there is no need for any more processing of debt service receipts for Hard Currency Bond 211 and the process goes back to step 705 where investor 105 can again exchange Hard Currency Back 211 to LITE Security 213. The revolving exchange between LITE Security 213 and Hard Currency Bond 211 at step 705 is also shown as 139a in FIG. 1c while step 716 is also shown as 139b in FIG. 1c.

If the answer to test 713 is “no”, meaning that investor 515 wishes to continue holding LITE Security 213, the process proceeds to step 714, where investor 515 waits for the next scheduled cash flow to be generated by Hard Currency Bond 211 to service the next scheduled interest and/or principal payment due under LITE Security 213. If there are no more schedule payments of interest and/or principal to be received under LITE Security 213, then LITE Security 213 has already matured and is no longer outstanding and investor 515 will no longer have to perform the method shown in FIG. 7 with respect to LITE Security 213.

Returning now test 709, when investor 105 checks to determine whether the cash flow from Hard Currency Bond 211 has been received, if the answer is “no”, meaning that the cash flow has not been received, investor 105 makes another determination at test 715 whether hard currency funds representing debt service for LITE Security 213 has been received through other means. Other means by which payment can be made independent of Hard Currency Bond 211 is shown in FIG. 4c. For example, Sovereign Government 501 could have wired hard currency funds directly to the fiscal or paying agent responsible for servicing LITE Security 213 or else to the account of Custodian 414 holding LITE Security 213 for investor 105. If the answer to test 715 is “yes”, the process proceeds to step 711 where investor 105 sets off local currency payables to Sovereign Government 501 against local currency receivables from Sovereign Government 501. From step 711, the other steps are performed which have been explained in the previous paragraphs.

Otherwise, if the answer to test 715 is “no”, meaning that hard currency debt service on LITE Security 213 has not been received by investor 105, then the process proceeds to step 717 where investor 105 receives local currency payments under Local Currency Bond 213a component of LITE Security 213 for which hard currency debt service was expected at step 715. This method of payment is shown under FIG. 4d.

From step 717, the process proceeds to step 719, where investor 105 receives the right to purchase hard currency funds from Resident Central Bank 403 in exchange for local currency. This right to purchase hard currency with local currency may be a right of Sovereign Government 501 which is assigned by Sovereign Government 501 to investor 105 and which investor 105 may then further assign to Resident Bank 515. The action of investor 105 receiving the assignment is shown at step 719. (It is not necessary that investor 105 receive the right to purchase hard currency funds for local currency after step 717. This right may be received at some earlier point, for example, after step 705, which is after LITE Security 213 is received from Sovereign Government 501.)

From step 719, the process proceeds to step 721 where investor 515 exchanges the local currency payment received at step 717 for hard currency funds. As explained in the description for FIG. 2, the cash flows of Local Currency Bond 213a which is a component of LITE Security 213 may be linked to Hard Currency Bond 211 through the exchange rate. The cash flows for Local Currency Bond 213a are periodically marked to market so that the local currency funds received as debt service at step 717 is at an amount sufficient to purchase the hard currency that should have been received by investor 105 at step 715. The hard currency funds received by investor 105 at step 721 may be received from Resident Central Bank 403 if Sovereign Government 515 assigns to investor 105 the right of Sovereign Government 501 to purchase hard currency from Resident Central Bank 403. In the event that Sovereign Government 501 does not exercise its right to purchase hard currency from Resident Central Bank 403, for example because of a condition of general debt moratorium on hard currency debt, investor 105 then purchases the hard currency from Resident Central Bank 403 as shown by step 721, instead of Sovereign Government 501 purchasing the hard currency. After step 721 is performed, the process proceeds to step 711. The steps that follow step 711 have been explained in the above paragraphs contained in this detailed description for FIG. 7.

### FIG. 7a:

FIG. 7a shows the prior art method for investing in Hard Currency Bond 211 issued by Sovereign Government 501, typically governed by either New York or English law. At step 701 a, investor 105 invests in Hard Currency Bond 211 issued by Sovereign Government 501. Investor 105 at step 701 a may be acting as a trustee for Resident Bank 515. If so, at step 703a, investor 105 issues beneficial interests in Hard Currency Bond 211 to Resident Bank 515. At test 705a, investor 105 determines whether Sovereign Government 501 which issued Hard Currency Bond 211 has paid the scheduled debt service for Hard Currency Bond 211 within the grace period, as provided by the indenture agreement governing Hard Currency Bond 211. Whether Sovereign Government 501 has paid the debt service can be determined by checking with the fiscal agent of Hard Currency Bond 211. If investor 515 determines at test 705a, that Sovereign Government 501 has indeed paid the scheduled debt service for Hard Currency Bond 211, investor 515 needs to do nothing more and simply waits for the next scheduled debt service payment due on Hard Currency Bond 211. If there are no more scheduled debt service payments following receipt of the latest scheduled debt service payment as determined by test 705a, Hard Currency Bond 211 has already matured, and is extinguished as an asset of investor 105 and also as a debt liability of Sovereign Government 501. After waiting for the date of the next scheduled debt service payment, and that date has arrived, the process goes back to step 705a and investor 105 again determines whether the scheduled debt service is received during the stated grace period.

However, if at test 705a, investor 105 determines that it did not receive the scheduled debt service within the stated grace period, the legal conclusion can be made that there is a payment default existing under Hard Currency Bond 211. Often, such a payment default would lead to acceleration of the principal due under Hard Currency Bond 211, which in turn could trigger acceleration of principal under other series of Hard Currency Bonds, or other hard-currency denominated debt issued by Sovereign Government 501 which are ranked equal to Hard Currency Bond 211. If Sovereign Government 501 is unable to satisfy the scheduled debt service following the grace period, or if Sovereign Government 501 is unable to satisfy the acceleration of principal amounts due under Hard Currency Bond 211, then the next step is shown at step 709a in which Hard Currency Bond 211 has to be restructured.

Sovereign debt restructuring can be a contentious and long drawn out process among various classes of investors negotiating with Sovereign Government 501. The outcome of the restructuring is often a write-down by investor 105 of some, if not all of the asset value attributed to Hard Currency Bond 211. The write-down shown at step 711 a may be the consequence of a bond exchange offered by Sovereign Government 501, in which the new bond being offered for Hard Currency Bond 211 being restructured at step 709a has a present value that is significantly less than the pre-default asset value of Hard Currency Bond 211 reflected in the books of investor 105. The difference in the present value of the bond being offered in exchange and the pre-default asset value of Hard Currency Bond 211 represents the write-down for investor 105 which may have to be reflected in the profit and loss statement of investor 105. The write-down results in a true loss of economic value for investor 105 which invests in Hard Currency Bond 211.

In contrast to the write-down that could result following a default of hard currency payments under Hard Currency Bond 211 as shown in FIG. 7a, LITE Security 213 provides investor 105 with greater protection against the risk of a hard currency payment default by Sovereign Government 501. This may not be obvious at first because Hard Currency Bond 211 and LITE Security 213 are both hard-currency debt securities issued by Sovereign Government 501. Since these are both unsecured and unsubordinated, it may not be obvious why the risks between Hard Currency Bond 211 and LITE Security 213 should be different.

Hard Currency Bond 211 is, of course, a natural hard currency denominated bond while LITE Security 213 is a synthetic hard currency denominated bond. It is in the underlying structure between natural and synthetic bonds that makes the difference in credit risk characteristic between the two debt securities. In the case of Hard Currency Bond 211, the only legal claim of investor 105 is in hard currency. On the other hand, investor 105 has a claim of local currency under LITE Security 213 because of the underlying Local Currency Bond 213a. Thus, during the event of a hard currency default under LITE Security 213, investor 105 would not necessarily come out empty handed as investor 105 would have a claim in local currency for the same value in hard currency as what would had been paid by Sovereign Government 501 had there been no hard currency default. Sovereign Governments everywhere can be expected to have much greater access to local currency, which is printed by its own Resident Central Bank, compared to hard currency which has to be accessed by a Sovereign Government or Resident Central Bank from foreign sources, which may be unwilling to provide such hard currency during a time of financial crisis that accompany default. Thus, most sovereign credit analysts consider the probability of a sovereign default in local currency to be lower than the probability of sovereign default under hard currency.

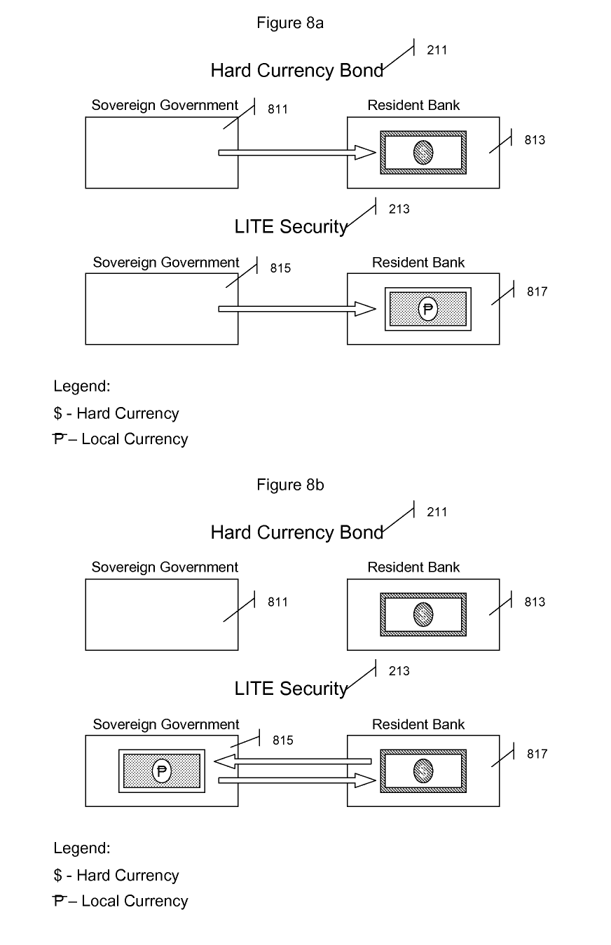

### FIG. 8a:

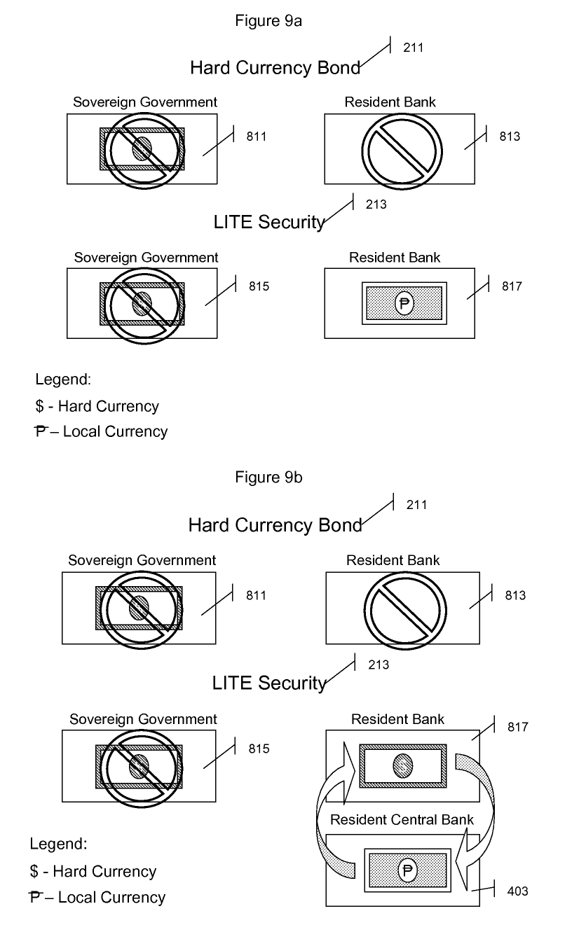

In FIG. 8a, FIG. 8b, FIG. 9a and FIG. 9b, Sovereign Government 501 is referred to as Sovereign Government 811 when it is acting as issuer of Hard Currency Bond 211 and as Sovereign Government 815 when it is acting as issuer of LITE Security 213. Also In FIG. 8a, FIG. 8b, FIG. 9a and FIG. 9b, Resident Bank 515 is referred to as Resident Bank 813 when it is acting as investor of Hard Currency Bond 211 and as Resident Bank 817 when it is acting as investor of LITE Security 213.

FIG. 8a and FIG. 8b that follows show why from a financial accounting viewpoint, Hard Currency Bond 211 and LITE Security 213 are both financial assets which are 100% denominated as hard currency. With respect to LITE Security 213, FIG. 8a and FIG. 8b are not intended to show the actual flow of funds between the Sovereign Government and the Resident Bank. Instead, FIG. 8a and FIG. 8b show the contractual terms contained in LITE Security 213. The actual flow of funds may be different because of set-offs as explained in the description for FIG. 3. In FIG. 8a, under Hard Currency Bond 211, Sovereign Government 811 pays the hard currency amount that is due under Hard Currency Bond 211 to Resident Bank 813. Thus, Resident Bank 813 ends up with hard currency funds in its account following debt service under Hard Currency Bond 211.

On the other hand, with respect to LITE Security 213, Sovereign Government 815 pays a local currency amount under Local Currency Bond 213a component of the LITE Security. Thus, if LITE Security 213 consisted solely of Local Currency Bond 213a, then Resident Bank 817 should end up exclusively with local currency funds as debt service. However, Local Currency Bond 213a is only one of the two components of LITE Security 213. The other component of LITE Security is Cross Currency Swap 213b, described in FIG. 2. FIG. 8b, that follows, shows how Cross Currency Swap 213b component of LITE Security 213 changes the kind of currency that is expected as debt service under LITE Security 213.

### FIG. 8b:

FIG. 8b shows how the local currency payments expected from Local Currency Bond 213a component of LITE Security 213 are converted to hard currency payments. Cross Currency Swap 213b component of LITE Security 213 requires that Sovereign Government 815 and Resident Bank 817 exchange currencies wherein Sovereign Government 815 pays Resident Bank 817 an amount in hard currency while Resident Bank 817 pays Sovereign Government 815 an amount in local currency. At FIG. 8b, this exchange of currencies is shown under the second row of boxes LITE Security 213. Resident Bank 817 delivers the local currency funds to Sovereign Government 815 in FIG. 8b, that Resident Bank 817 received in FIG. 8a under LITE Security 213. Simultaneously, Sovereign Government 815 delivers hard currency funds to Resident Bank 817.

After the exchange of currencies under Cross Currency Swap 213b as shown under FIG. 8b, Resident Bank 817 ends up in the same position as it would have been, had Resident Bank 817 invested in Hard Currency Bond 211 instead of LITE Security 213 assuming there was no default under either debt security. The fact that Resident Bank 817 achieves the same end result, meaning a hard currency long position, regardless of whether Resident Bank 817 is holding Hard Currency Bond 211 or LITE Security 213, is the reason why both Hard Currency Bond 211 and LITE Security 213 should be accounted for by Resident Bank 817, as a 100% hard currency denominated asset.

### FIG. 9a:

FIG. 9a and FIG. 9b show the “other side of the coin” that is shown by FIG. 8a and FIG. 8b. FIG. 8a and FIG. 8b show what occurs when there is no payment default by Sovereign Government 811 under Hard Currency Bond 211 or by Sovereign Government 815 under LITE Security 213. On the other hand, FIG. 9a and FIG. 9b show what can occur if there is a payment default by Sovereign Government 811 and Sovereign Government 815. In general, financial accounting is concerned with the representation of a contract assuming that the parties to the contract perform their contractual promises. On the other hand, credit exposure measurement, which is one of the purposes of the Basel II capital standards, is concerned with the situation where the issuer does not perform its obligations under debt securities that it issued.

In scenario showed by FIG. 9a, Sovereign Government 811 which has issued Hard Currency Bond 211 does not have any available hard currency to service Hard Currency Bond 211. This is indicated by the “no” symbol over the hard currency showed under Sovereign Government 811. There is a payment default under Hard Currency Bond 211 and Resident Bank 813 ends up empty handed, with neither hard currency nor local currency. On the other hand, Sovereign Government 815, which issued LITE Security 213, is able to service Local Currency Bond 213a component of LITE Security 213 despite the fact that Sovereign Government 815 does not have any hard currency available. Resident Bank 817 ends up with local currency received from Sovereign Government 815. The equal rank provision of hard currency debt issued by a Sovereign Government usually covers all other debt of that Sovereign Government that is denominated in hard currency. As a result, a Sovereign Government that defaults under one series of Hard Currency Bonds should not continue to service other series of Hard Currency Bonds or other forms of hard currency debt issued by the Sovereign Government. However, local currency denominated debt issued by the Sovereign Government, such as Local Currency Bond 213a that is a component of LITE Security 213, is something different from a Hard Currency Bond and is almost always carved out of equal rank provisions given to the holders of Hard Currency Bonds. Thus, Sovereign Government 815 may be contractually able to continue servicing Local Currency Bond 213a component of LITE Security 213 although that same Sovereign Government may have already ceased making payments under Hard Currency Bond 211.

### FIG. 9b:

FIG. 9b shows what Resident Bank 817 can do to achieve its expected hard currency position, despite the fact that Sovereign Government 815 does not have any available hard currency funds to exchange with Resident Bank 817. During such a situation, Sovereign Government 815 will be unable to perform its obligation to exchange currencies under Cross Currency Swap 213b component of LITE Security 213. Resident Bank 817 can find a third party, for example, Resident Central Bank 403, to exchange Resident Bank 817's local currency for hard currency. The right to exchange local currency for hard currency from Resident Central Bank 403 may have been a pre-existing right of Sovereign Government 815 which was assigned to Resident Bank 817 as shown by 621 in FIG. 6 as part of the agreement involving the issuance of the LITE Security 213.

The fact the amount of local currency to be paid by Sovereign Government 815 is based on the local currency equivalent of the hard currency that would have otherwise been due, as calculated at step 618 in FIG. 6, means that Resident Bank 817 should have sufficient local currency to purchase the amount of hard currency from Resident Central Bank 403, that it would have received directly from Sovereign Government 815 had Sovereign Government 815 had the available hard currency funds to pay Resident Bank 817 directly. Thus, FIG. 9b shows that at the end of the day, Resident Bank 817 ends up with the same amount of hard currency as Resident Bank 817 ended up with under FIG. 8b, when there was no default under Hard Currency Bond 211. FIG. 9b shows why Resident Bank 817 does not depend on Sovereign Government 815 in order for Resident Bank 817 to be in the hard currency long position that it bargained for when Resident Bank 817 invested in LITE Security 213. Resident Bank 817 relies on Sovereign Government 815 in repaying the LITE Security 213 in local currency, while Resident Bank 813 relies on Sovereign Government 811 in repaying the Hard Currency Debt 211 in hard currency.

### FIG. 10:

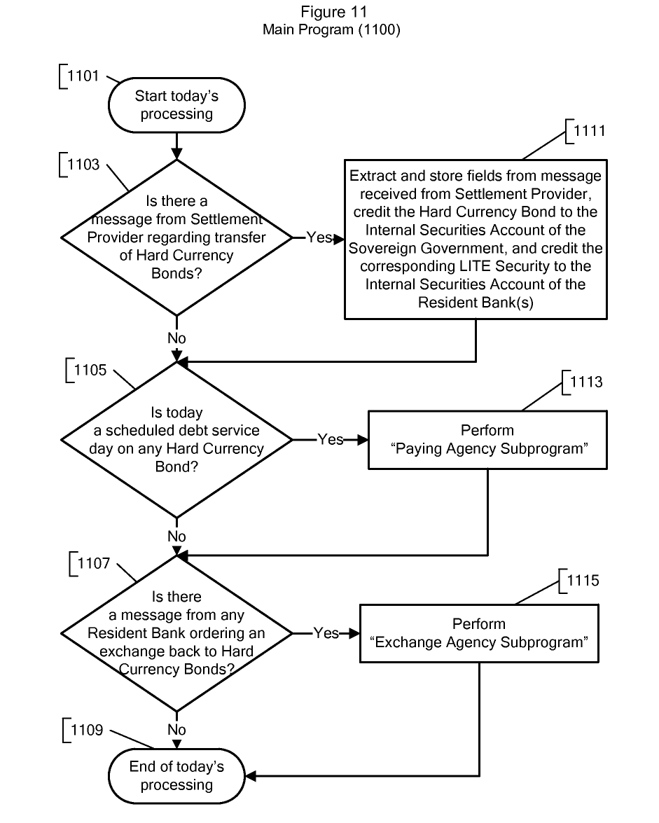

FIG. 10 shows computer system or apparatus 1001 of the present invention. Computer system 1001 is comprised of a general purpose computer which may be a mainframe, single server processor or group of server processors that distribute processing but act together to execute the program instructions described in FIGS. 11-13. Computer system 1001 may include terminals to accept manual inputs and devices to print or display information needed for action by an administrator. Computer system 1001 may also be comprised of random access memory by which computer system 1001 can execute a software program, non-volatile memory by which computer system 1001 can access or store information in a file or database, input-output devices such as printers, monitors, keyboards and pointing devices. Computer system 1001 communicates with three classes of parties through a communications links 1009, 1011 and 1013 that would permit computer-to-computer straight-through processing, or processing with manual intervention, such as a human operator or administrator communicating with the three parties through telephone, telefax and/or courier. The three classes of parties which are linked to the computer system or apparatus are Settlement Provider 1003 which is linked through Communications Link 1009, Resident Central Bank 403 which is linked through Communications Link 1011, and Resident Bank 515 which is linked through Communications Link 1013.

Computer System 1001 maintains an account such as Internal Cash Account 1001 a and an account such as Internal Securities Account 1001b for each of the clients served by Computer System 1001. The computer system of Settlement Provider 1003 is not shown, but it maintains accounts such as External Cash Account 1003a and accounts such as External Securities Account 1003b for each of the clients served by Settlement Provider 1003. The computer system of Resident Central Bank 403 is not shown, but it maintains accounts such as External Cash Account 1005a for each of its clients, which may include Resident Bank 515.

### FIG. 11:

FIG. 11 shows a flow chart of the main program of the present invention that would execute on the Computer System 1001 in FIG. 10. The main program 1100 shown in FIG. 11 is intended to be executed on a daily basis, at least on any day when business activity or payment activity involving LITE Security 213 or corresponding Hard Currency Bond 211 may occur. Step 1101 marks the start of Program 1100.

At test 1103, program 1100 checks whether Settlement Provider 1003, in which Custodian 414 maintains an account, has received ownership of Hard Currency Bond 211. Custodian 414 is supposed to hold ownership of Hard Currency Bond 211 for the benefit of Sovereign Government 501. If the answer to test 1103 is “yes”, Program 1100 proceeds to step 1111 where program 1100 extracts relevant fields and stores this in non-volatile memory. The information extracted from the message received at step 1103 may include the total value of Hard Currency Bond 211, the ISIN number of Hard Currency Bond 211, and the transferor of Hard Currency Bond 211. Additional information regarding the transfer of Hard Currency Bond 211 may also be extracted by program 1100 and stored in non-volatile memory. Program 1100 then writes a computer record indicating a credit entry for Hard Currency Bond 211 into Internal Securities Account 1001b of Sovereign Government 501. Program 1100 then writes a computer record indicating a credit entry for corresponding LITE Security 213 into Internal Securities Account 1001b of Resident Bank 515 or investor 105 in LITE Security 213 indicating that Resident Bank 515 or investor 105 is the true beneficial owner of LITE Security 213 that has been given to it in exchange for Hard Currency Bond 211. Before writing the record indicating a long position in LITE Security 213 to non-volatile memory, program 1100 may require manual intervention from a human administrator indicating that Custodian 414 has received physical documents evidencing the issuance of LITE Security 213 by Sovereign Government 501.

If the answer to test 1103 is “no”, program 1100 proceeds to test 1105 which is another inquiry to determine whether there is a scheduled debt service due for the current day involving any Hard Currency Bond that has been previously transferred to Custodian 414 at step 1103 (not necessarily on the same day). Test 1105 can be determined by looping through the database list of all the series of Hard Currency Bonds presently held by Custodian 414 for the benefit of Sovereign Government 501, and for which corresponding LITE Security 213 has been issued, as shown by the exchange shown in FIG. 1. If the answer to test 1105 is “yes”, program 1100 branches off to paying agency subprogram 1200 at step 1113. From step 1113, paying agency subprogram 1200 proceeds independently of the main program 1100. With respect to any Hard Currency Bond, paying agency subprogram 1200 need not be completed during the same day when it is called by main program 1100; however, after paying agency subprogram 1200 is called, main program 1100 proceeds to 1107 without waiting for the called paying agency subprogram 1200 to terminate.

Regardless of the answer to test 1105, the program 1100 proceeds to test 1107 in which it is determined whether there has been a message received from any Resident Bank such as Resident Bank 515 ordering an exchange of LITE Security 213 owned by Resident Bank 515 for the corresponding Hard Currency Bond 211 owned by Sovereign Government 501 and held by Custodian 414. If the answer to test 1107 is “yes”, program 1100 calls exchange agency subprogram 1300 at step 1115. From there, the exchange agency subprogram 1300 proceeds independently of the main program 1100. With respect to any LITE Security being exchanged to a Hard Currency Bond, the exchange agency subprogram 1300 need not be completed during the same day when it is first called by the main program 1100. After exchange agency subprogram 1300 is called, main program 1100 proceeds to step 1109 without waiting for the called exchange agency subprogram 1300 to terminate.

Regardless of the answer test 1107, main program 1100 proceeds to step 1109 which marks the end of the execution for main program 1100 for that day. The main program 1100 is then executed again starting from step 1101 at the next business day.

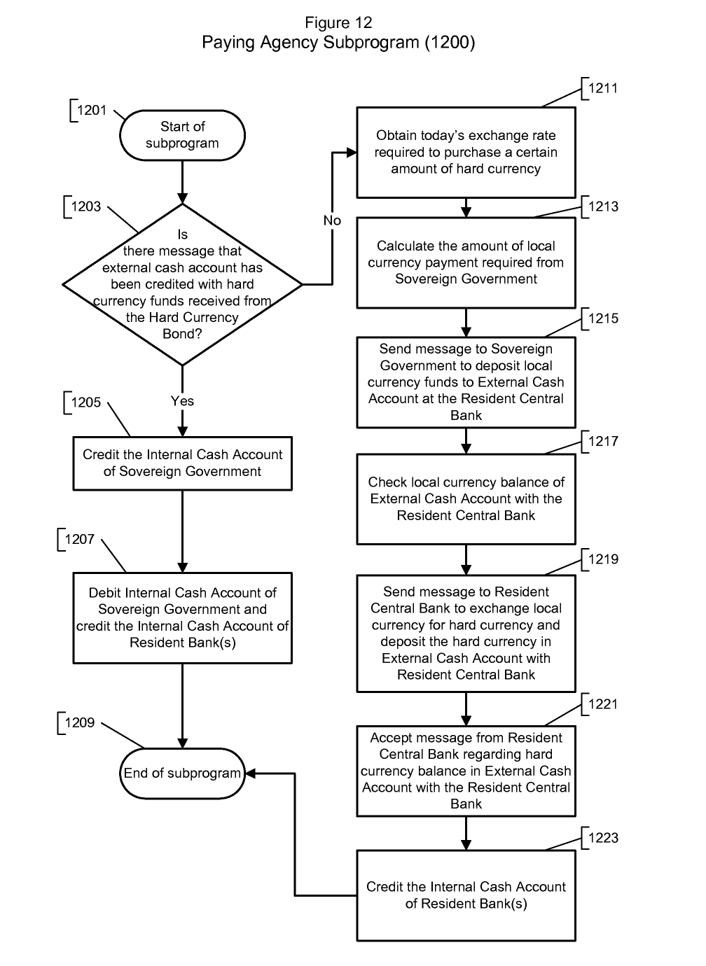

### FIG. 12:

FIG. 12 shows a flow chart for the paying agency subprogram 1200 which may be called into execution by the main program 1100 at step 1113. Step 1201 marks the start of the subprogram 1200. At test 1203, subprogram 1200 determines whether there is a message indicating that External Cash Account 1003a with Settlement Provider 1003 has been credited with an amount of hard currency resulting from a payment of interest and/or principal received under Hard Currency Bond 211. Hard Currency 211 is held by Custodian 414 for the benefit of Sovereign Government 501 but deposited by Custodian 414 with Settlement Provider 1003. The message to be checked at test 1203 may be received autonomously or may be triggered by a status query sent by paying agency subprogram 1200 to Settlement Provider 1003. If the answer to test 1203 is “no” (meaning that Sovereign Government 501, which issued Hard Currency Bond 211 for which payment is due, has failed to pay the scheduled debt service under Hard Currency Bond 211), then execution of subprogram 1200 proceeds to step 1211 where subprogram 1200 obtains the exchange rate required to purchase the hard currency for which payment was determined to have been missed by the test 1203. The exchange rate for the currency exchange may be obtained by telephoning Resident Central Bank 403 and manually inputting the exchange rate indicated by Resident Central Bank 403 into subprogram 1200.

At step 1213, subprogram 1200 calculates the amount of local currency that is due from Sovereign Government 501 under Local Currency Bond 213a component of LITE Security 213. This amount of local currency may be printed by subprogram 1200 in a report and the resulting information electronically transmitted to Sovereign Government 501 at step 1215, or it may be manually transmitted by Custodian 414 to Sovereign Government 501 by telephone, telefax or courier message. At step 1217, subprogram 1200 checks the local currency balance of External Cash Account 1005a of Custodian 414 with Resident Central Bank 403. This checking of the local currency balance can be performed by straight-through processing with Resident Central Bank 403, or alternatively by Custodian 414 manually telephoning or writing Resident Central Bank 403 and inputting the balance information received from Resident Central Bank 403 into the subprogram.

At step 1219, subprogram 1200 sends a message to Resident Central Bank 403 to exchange the balance of local currency which was confirmed at step 1217 into hard currency, and to deposit the resulting hard currency into External Cash Account 1005a of Custodian 414 with Resident Central Bank 403. The message sent at step 1219 may be transmitted by subprogram 1200 to Resident Central Bank 403 through straight-through processing, or alternatively, subprogram 1200 may prompt an administrator working for Custodian 414 to manually telephone Resident Central Bank 403 and provide the message to be given at step 1219.

At step 1221, subprogram 1200 receives the message that Resident Central Bank 403 has credited the hard currency (referred to at step 1219) to the External Cash Account 1005a with Resident Central Bank 403. The message received by subprogram 1200 at step 1221 may be received directly from Resident Central Bank 403 through straight-through processing or alternatively, may be received by Custodian 414 through telephone, fax or courier and inputted manually by Custodian 414 into subprogram 1200. Finally, at step 1223, subprogram 1200 distributes the gross amount of the hard currency funds deposited at the External Cash Account 1005a of Custodian 414 with Resident Central Bank 403 to one or more Resident Banks which own one or more LITE Securities corresponding to the Hard Currency 211 referred to at step 1203. This distribution is performed by subprogram 1200 at step 1223 by crediting the Internal Cash Account such as Internal Cash Account 1001a of the various Resident Banks which own LITE Securities corresponding to Hard Currency Bond 211.

However, if the answer to test 1203 is “yes”, subprogram 1200 executes step 1205 where subprogram credits Internal Cash Account 1005a of Sovereign Government 501 with the same hard currency amount that was credited to External Cash Account 1003a as confirmed by message received at step 1203. At step 1207, subprogram 1200 debits Internal Cash Account 1005a of the Sovereign Government in the same amount that was credited at step 1205 (effectively reversing the amount of the credit at step 1205) and simultaneously distributes the credits to the Internal Cash Accounts such as Internal Cash Account 1005a of one or more Resident Banks in proportion with and according to the amount of LITE Security 213 which the Resident Bank owns and which corresponds to Hard Currency Bond 211 referred to at step 1203.

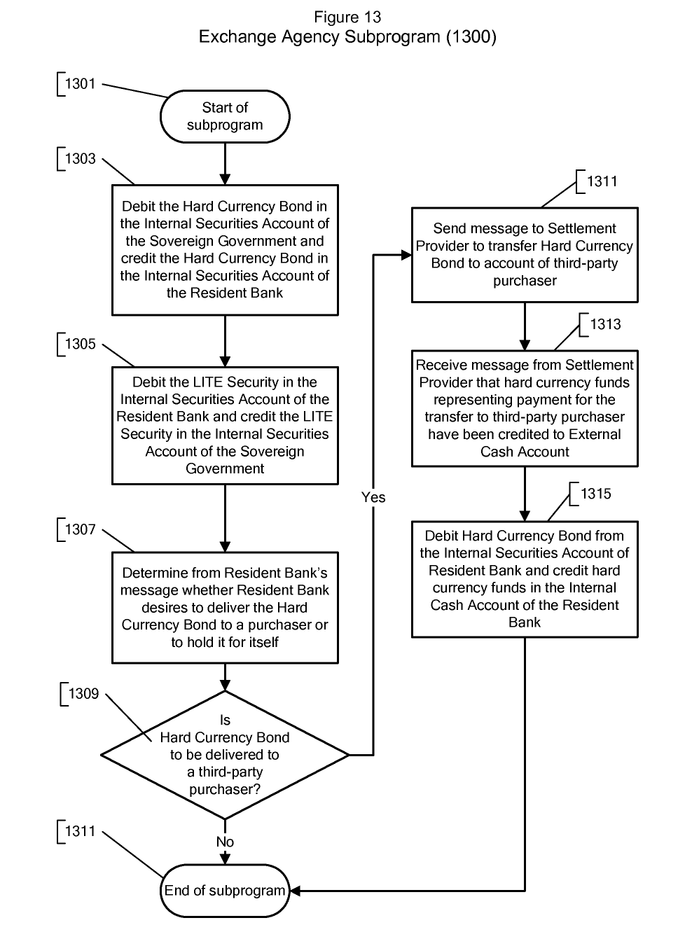

### FIG. 13:

FIG. 13 shows a flow chart for exchange agency subprogram 1300 which may be called into execution by main program 1100. Step 1301 marks the start of subprogram 1300. At step 1303, subprogram 1300 debits Hard Currency Bond 211 (which corresponds to LITE Security 213 which is referred to in test 1107 in FIG. 11) to Internal Securities Account 1001b of Sovereign Government 501 while crediting Hard Currency Bond 211 to Internal Securities Account 1001b of Resident Bank 515. Note that the bookkeeping performed at step 1303 represents a change as to which client, Sovereign Government 501 or Resident Bank 515, would own Hard Currency Bond 211 or LITE Security 213, which may be held for one or the other client by Custodian 414. Both Resident Bank 515 and Sovereign Government 501 are clients of Custodian 414.

At step 1305, subprogram 1300 debits LITE Security 213 (which is referred to in test 1107 in FIG. 11) in Internal Securities Account 1001b of Resident Bank 515 and credits LITE Security 213 in Internal Securities Account 1001b of Sovereign Government 501. After Sovereign Government 501 receives ownership of LITE Security 213 at step 1305, Sovereign Government 501 may choose to cancel or retire LITE Security 213 so that it can no longer be re-assigned or resold to a third party. On the other hand, Sovereign Government 501 may choose to maintain LITE Security 213 in case of a transfer in the future such as that which is shown at step 1111 in FIG. 11.

At step 1307, subprogram 1300 determines from the message received at step 1107 in FIG. 11, whether Resident Bank 515 desires that Hard Currency Bond 211 be delivered to its Internal Securities Account 1001b with Custodian 414 or whether Resident Bank 515 desires that Hard Currency Bond 211 be delivered to the account of a third party purchaser, which may not be a client of Custodian 414 and which may require delivery of Hard Currency Bond 211 through a Settlement Provider. Through the use of the present invention as disclosed in FIG. 13, Resident Bank 515 may sell Hard Currency Bond 211, as if Resident Bank 515 already owned it, even before initiating the exchange back of LITE Security 213 for the corresponding Hard Currency Bond 211 by sending the message to Custodian 414 as tested at test 1107 in FIG. 11.

After the message from Resident Bank 515 at step 1307 is parsed and reviewed by subprogram 1300, subprogram 1300 determines at step 1309 whether Hard Currency Bond 211 is to be delivered to the account of the third-party purchaser, which purchased Hard Currency Bond 211 from Resident Bank 515. If the answer to test 1309 is “yes”, subprogram 1300 goes to step 1311, where subprogram 1300 sends a message to Settlement Provider 1003 to cause Hard Currency Bond 211 to be transferred to the account of the third-party purchaser. The third-party purchaser, or the third-party purchaser's securities custodian, may have a securities account at Settlement Provider 1003 or with another Settlement Provider which inter-operates with Settlement Provider 1003. The message may be sent electronically by computer system 1001 disclosed in FIG. 10 through straight-through processing, or computer system 1001 may generate a report requiring manual delivery of the message by a human administrator through telephone, telefax or courier.

Once the funds have been received, indicating payment for Hard Currency Bond 211 which were transferred and referred to at step 1311, the External Cash Account 1003a of Custodian 414 which may be held with Settlement Provider 1003 is credited with such hard currency funds received from the purchaser of Hard Currency Bond 211. At step 1313, subprogram 1300 receives a message indicating that funds have been successfully credited to External Cash Account 1003a. This message may be sent by Settlement Provider 1003 to computer system 1001 disclosed in FIG. 10 through straight-through processing or Settlement Provider 1003 may provide the message through telefax, courier or telephone to a human administrator of computer system 1001, who then manually inputs the message into computer system 1001.

Finally, at step 1315, subprogram 1300 debits Hard Currency Bond 211 in Internal Securities Account 1001b of Resident Bank 515, which initiated the process to transfer Hard Currency Bond 211 to the third-party purchaser, and then credits Internal Cash Account 1001 a of Resident Bank 515 in the amount indicated by the message received at step 1313. Subprogram 1300 terminates at step 1311 which follows step 1315.

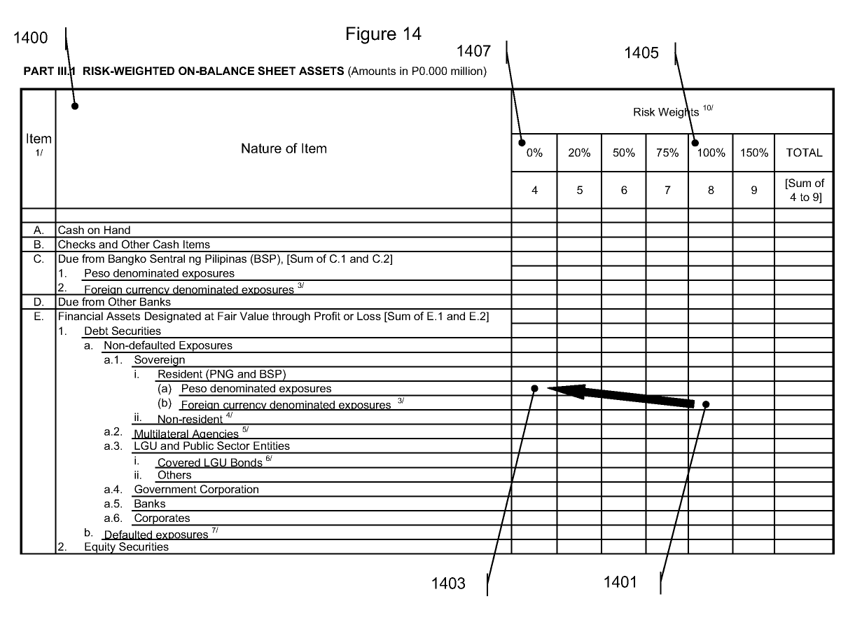

If on the other hand, the answer to test 1309, is “no”, subprogram 1300 proceeds to step 1311 where subprogram 1300 terminates until it is called again by main program 1100. No other book entries need to be performed at this point as the internal transfers of Hard Currency Bond 211 and LITE Security 213 have already been performed at step 1303 and step 1305. FIG. 14:

FIG. 14 shows an example of a form that is used by a Resident Central Bank such as Resident Central Bank 403 to determine the credit risk weight to be assigned to financial assets owned by a Resident Bank such as Resident Bank 515 supervised by Resident Central Bank 403. Form 1400 shown at FIG. 14 applies to those financial assets which are designated at “Fair Value through Profit or Loss”. Besides “Fair Value through Profit and Loss”, financial assets also may be held as “Available for Sale” or “Held to Maturity”, but the application of the concept illustrated by FIG. 14 remains the same. In form 1400 shown in FIG. 14, hard currency denominated debt issued by the resident sovereign, referred to as “foreign currency denominated exposures” in form 1400, is given a risk weight of 100%, as marked by column 1405. The international capital standard known as Basel II require reporting banks to use a risk weight of 100%, in the calculation of bank capital adequacy, for all financial assets or claims which bear a credit rating between BB+and B-. This refers to the credit rating assigned to that financial asset by external credit rating agencies. Before the use of the present invention, Resident Bank 515 completing form 1400 would need to fill in the value of Hard Currency Bond 211 that owned by Resident Bank 515 in cell 1401. However, the Basel II standards also gives Resident Central Bank 403 the discretion to allow a much lower risk weight, typically zero, to debt issued by its resident sovereign, which is Sovereign Government 501, provided such debt of Sovereign Government 501 is denominated in local currency and is funded by the bank holding such debt in local currency. “Funded by local currency” means that the bank holding the local currency debt asset also has liabilities, which are denominated in local currency, corresponding to that local currency debt asset. The lower risk weight of zero, which has been assigned by Resident Central Bank 403 which authored form 1400, is marked by column 1407. The present invention allows Resident Bank 515 to shift the risk weight of its financial asset, which is the debt issued by Sovereign Government 501, from 100% to 0% by shifting the reporting of such financial asset from the cell 1401 to the cell 1403.

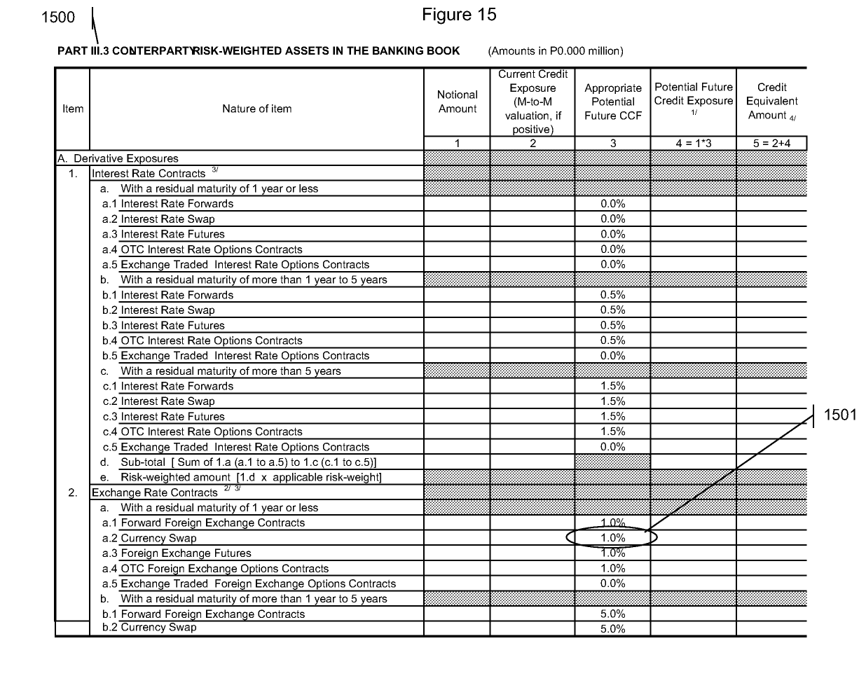

### FIG. 15:

FIG. 15 shows form 1500 which is an example of a form that is used by a Resident Central Bank to determine the credit risk weight to be assigned to Cross Currency Swap 213b component of LITE Security 213. The international capital standards known as Basel II require two components of credit risk weight to be applied to the notional value of any exchange contract such as Cross Currency Swap 213b. The two components are referred to as the “add-on factor” and the “current credit exposure”. The “add-on factor” varies according to the tenor of the exchange contract. For exchange contracts, such as Cross Currency Swap 213b, which is a component of LITE Security 213, and which according to its terms, is marked to market during recurring periods of one year or shorter, the “add-on factor” of the exchange contract is equal to 1.0% of notional value as shown by 1501. Because Cross Currency Swap 213b is marked to market often (i.e. daily) the “current credit exposure” at any time, which is the market value at that time, of Cross Currency Swap 213b is almost always equal to zero. Thus, the combined credit risk weight for LITE Security 213 is a lower credit risk weight compared to that of Hard Currency Bond 211. This lower risk weight of LITE Security 213 is attributable to the sum of its two components: Local Currency Bond 213a (with risk weight reported in form 1400) and Cross Currency Swap 213b (with risk weight reported in form 1500). Thus, based on the risk weights assigned in form 1400 and form 1500, LITE Security 213b has a combined credit risk weight of 1%, which compares very favorably to the credit risk weight of 100% for Hard Currency Bond 211, which LITE Security 213 replaces.

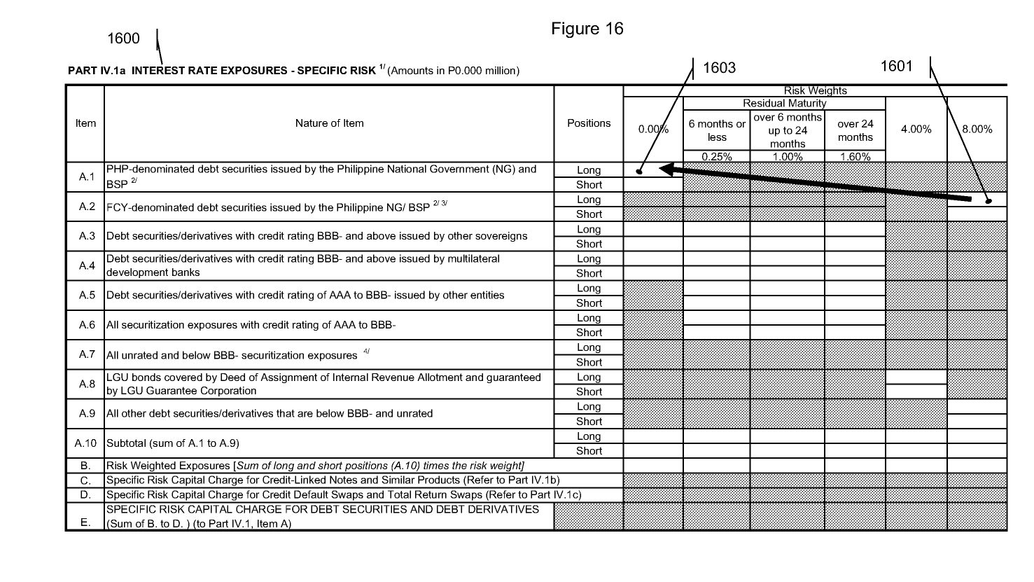

### FIG. 16:

The international capital standards known as Basel II require a reporting bank to calculate risk weights according to the credit risks, market risks and operational risks borne by the reporting bank. Form 1400 and form 1500 showed how the credit risk weight for LITE Security 213 is calculated, which is a significant reduction compared to what would be assigned to Hard Currency Bond 211, especially if the external credit rating of Currency Bond 211 is BB+or below (i.e. speculative grade).

Market risk weight involves positions in the trading book of a reporting bank. For bonds issued by Sovereign Government 501, the market risk weight for any long position in such bonds can come from the contribution of its long position to “specific risk” and also to “general market risk”. Form 1600 shows an example of what is used by a Resident Central Bank to determine market risk weight for LITE Security 213 with respect to “specific risk”. The example shows that Resident Bank 515 can shift its specific risk weight from 8.0% to 0.0% by exchanging its Hard Currency Bond 211 issued by Sovereign Government 501 for LITE Security 213, which is also to be issued by Sovereign Government 501. The shift in risk weight attributable to such shift can be seen in form 1600 from the movement of the value reported by Resident Bank 515 from the cell 1601 to the cell 1603.

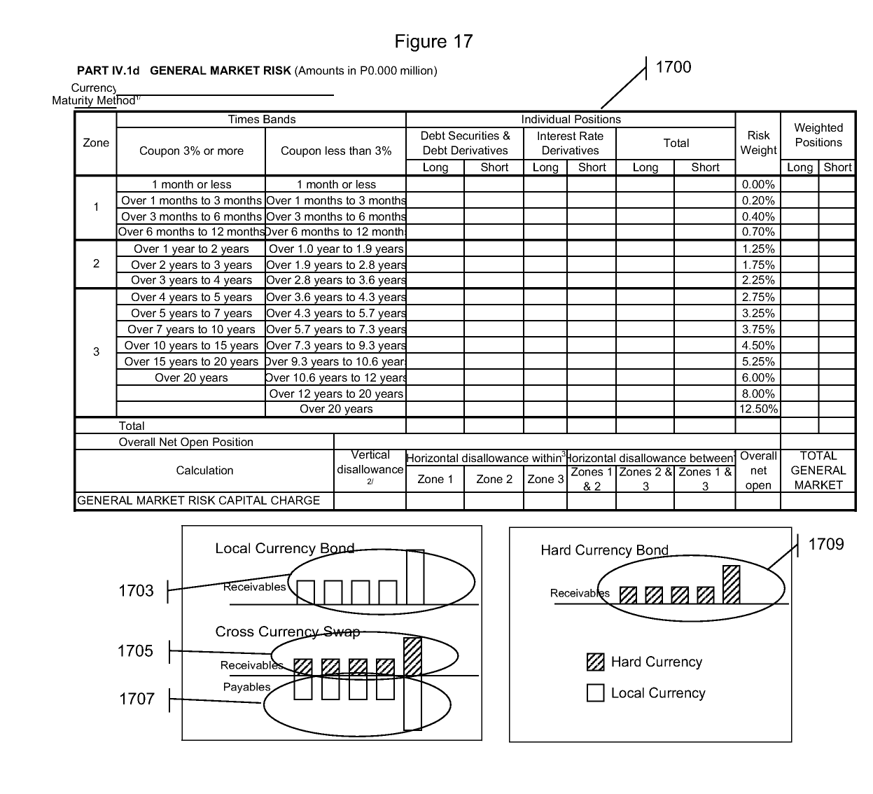

### FIG. 17:

Form 1700 shows how the risk weight for general market risk may be calculated for Resident Bank 515 which is holding LITE Security 213. “General market risk” refers to the amount of risk attributable to the mismatch in timing and amount of the reporting entity's various long and short positions in its trading books with respect to various currencies. The long and short positions refer to fixed receivables and fixed payables of Resident Bank 515 for any given currency. As can be seen on the upper left hand corner of the form, the general market risk calculation is to be completed for every currency that Resident Bank 515 has a position in (whether long or short).

Under general market risk calculation under Basel II (which remained unchanged from Basel I), Resident Bank 515, which is long LITE Security 213, reports only the hard currency leg of Cross Currency Swap 213b as shown by hard currency flows 1705. There is no need for Resident Bank 515 to individually report Local Currency Bond 213a component, which is a long local currency position as shown by local currency flows 1703, and the local currency leg of Cross Currency Swap 213b, which is a local currency short position as shown by local currency flows 1707, because Basel II allows opposing long and short positions to be offset against each other, provided that these two positions have the same interest rate, maturity, currency and issuer. This is the case LITE Security 213 because of the reasons described in FIG. 2. Thus, for general market risk calculation purposes, the local currency flows 1703 and local currency flows 1707 are ignored and only the hard currency flows 1705 are involved in the calculation.

Provided there is no existing default under either Hard Currency Bond 211 or LITE Security 213, there will be no difference in the general market risk calculation for LITE Security 213 (which is the net sum of inflows 1703, outflows 1705 and inflows 1707) compared to the general market risk calculation for the corresponding Hard Currency Bond 211, which has inflows 1709.

1. A method of investing in a low credit risk weight debt security comprising the steps of:
receiving a first debt security which is denominated in a hard currency and which has hard currency debt service;
transferring a second debt security which is denominated in said hard currency of said first debt security wherein said second debt security is exchanged for said first debt security; and
wherein said first debt security and said second debt security are the obligations of a single issuer; and
wherein scheduled debt service remaining under said second debt security is substantially equivalent to scheduled debt service remaining under said first debt security; and
wherein said first debt security has means for converting said hard currency debt service under said first debt security into local currency debt service if issuer of said first debt security cannot pay said hard currency debt service.

2. The method of claim 1 further comprising exchanging said first debt security for said second debt security.

3. The method of claim 2 further comprising receiving assignment of a right to purchase hard currency from a resident central bank through the use of said local currency debt service.

4-13. (canceled)

14. A method of servicing a low credit risk weight debt security comprising the steps of:
servicing a first debt security; and
wherein said first debt security is comprised of:
an obligation of the issuer of said first debt security to pay hard currency debt service; and
means for converting said hard currency debt service under said first debt security into local currency debt service if said issuer of said first debt security cannot pay said hard currency debt service; and
a right of the holder of said first security to receive a second debt security in exchange for said first debt security; and
said first debt security and said second debt security are the obligations of a single issuer; and
scheduled debt service remaining under said second debt security is substantially equivalent to scheduled debt service remaining under said first debt security.

15. The method of claim 14 wherein said first debt security is further comprised of an obligation of said issuer of said first debt security to deliver said first debt security in exchange for said second debt security.

16. The method of claim 15 wherein said first debt security is further comprised of an assignment to the holder of said first debt security of a right to purchase hard currency with said local currency; and wherein said right to purchase hard currency is from a central bank residing in the country of said issuer of said second debt security.

17. A method of receiving debt service on a low credit risk weight debt security comprising the steps of:
receiving debt service on a first debt security; and
wherein said first debt security is comprised of:
an obligation of the issuer of said first debt security to pay hard currency debt service; and
means for converting said hard currency debt service under said first debt security into local currency debt service if said issuer of said first debt security cannot pay said hard currency debt service; and
a right of the holder of said first security to receive a second debt security in exchange for said first debt security; and
said first debt security and said second debt security are the obligations of a single issuer; and
scheduled debt service remaining under said second debt security is substantially equivalent to scheduled debt service remaining under said first debt security.

18. The method of claim 17 wherein said first debt security is further comprised of an obligation of said issuer of said first debt security to deliver said first debt security in exchange for said second debt security.

19. The method of claim 18 wherein said first debt security is further comprised of an assignment to the holder of said first debt security of a right to purchase hard currency with said local currency; and wherein said right to purchase hard currency is from a central bank residing in the country of said issuer of said second debt security.
